(19) United States
(12) Patent Application Publication
(10) Pub. No.: US 2017/0230619 A1
(43) Pub. Date: Aug. 10, 2017

(54) REPRODUCTION DEVICE AND REMOTE SIMULTANEOUS VIEWING MANAGEMENT DEVICE

(71) Applicant: SHARP KABUSHIKI KAISHA, Sakai City, Osaka (JP)

(72) Inventors: Atsutoshi SHIMENO, Sakai City (JP); Takashi KANEKO, Sakai City (JP); Masahiro SHIOI, Sakai City (JP); Chanbin NI, Sakai City (JP); Norio ITOH, Sakai City (JP)

(73) Assignee: SHARP KABUSHIKI KAISHA, Sakai City, Osaka (JP)

(21) Appl. No.: 15/501,922

(22) PCT Filed: Jul. 24, 2015
(86) PCT No.: PCT/JP2015/071158

§ 371 Date: Mar. 13, 2017

(30) Foreign Application Priority Data
Aug. 8, 2014 (JP) 2014-163082

(51) Int. Cl. H04N 7/15; H04N 21/239; G06F 17/30; H04N 21/2187

(52) U.S. Cl. CPC H04N 7/15; H04N 21/2187; H04N 21/2396; G06F 17/30035; G06Q 50/00

(57) ABSTRACT

In a remote simultaneous viewing system, zapping for a different group that views a content having the same attribute as that of a content viewed by a belonging group of a user is enabled. A content reproduction portion (22) that reproduces a content; and a group switching portion (25) that switches a belonging group of a user to a different group that views a content having the same attribute as that of the reproduced content are included.

### TECHNICAL FIELD

The present invention relates to a reproduction device and a remote simultaneous viewing management device that realize remote simultaneous viewing that, in a case where there are a plurality of groups to each of which one or a plurality of users belong, users who belong to the same group view the same content.

### BACKGROUND ART

Heretofore, there has been a technique which provides a virtual communication space such as a chat room or an electronic bulletin board for a viewer of a video content or an audio content. For example, PTL 1 describes that users who have the same information related to a viewing situation of a content are grouped and a virtual communication space is provided for each group.

### CITATION LIST

### Patent Literature

PTL 1: Japanese Unexamined Patent Application Publication No. 2006-108996 (published on Apr. 20, 2006)

### SUMMARY OF INVENTION

### Technical Problem

Currently, a remote simultaneous viewing system is being developed. In the remote simultaneous viewing system, there are a plurality of groups to each of which one or a plurality of users belong, and users who belong to the same group view the same content. Moreover, users who belong to the same group are able to communicate by a chat or the like, while viewing the same content.

In such a remote simultaneous viewing system, a user wants to change a person to communicate with, that is, to change a group to belong to, in some cases. However, in an existing technique such as the above-described one, since only one group is set with respect to one condition, there is a problem that it is difficult for a user to perform zapping for another group which views a content having the same attribute as that of a content which is viewed by a group currently participated in (to switch a belonging group to another group).

The invention is made in view of the aforementioned problem, and an object thereof is to realize a reproduction device and a remote simultaneous viewing management device that, in a remote simultaneous viewing system, enable zapping for another group which views a content having the same attribute as that of a content viewed by a group to which a user belongs.

### Solution to Problem

In order to solve the aforementioned problem, a reproduction device according to an aspect of the invention is a reproduction device that is included in a remote simultaneous viewing system in which there are a plurality of groups, to each of which one or a plurality of users belong, and users who belong to a same group view a same content, including: a reproduction portion that reproduces a content; and a switching portion that switches a belonging group of a user of the reproduction device to a different group that views a content having a same attribute as that of the content reproduced by the reproduction portion.

In order to solve the aforementioned problem, a remote simultaneous viewing management device according to an aspect of the invention is a remote simultaneous viewing management device that is included in a remote simultaneous viewing system in which there are a plurality of groups, to each of which one or a plurality of users belong, and users who belong to a same group view a same content, including: a reception portion that receives a belonging group switching instruction from a reproduction device of a user; and a switching portion that switches a belonging group of the user to a different group, which views a content having a same attribute as that of a content reproduced by the reproduction device, on a basis of the belonging group switching instruction received by the reception portion.

### Advantageous Effects of Invention

According to an aspect of the invention, an effect of switching to another group which views a content having the same attribute as that of a content viewed by a user.

### BRIEF DESCRIPTION OF DRAWINGS

FIG. 1 is a block diagram illustrating an example of a configuration of a main part of a reproduction device according to Embodiment 1 of the invention.

FIG. 2 is a block diagram illustrating an example of a configuration of a main part of a server according to Embodiment 1 of the invention.

FIG. 3 illustrates an example of a schematic view of a remote simultaneous viewing system according to Embodiment 1 of the invention.

FIG. 4 is a view illustrating an example of content management information according to Embodiment 1 of the invention.

FIG. 5 is a view illustrating an example of group information according to Embodiment 1 of the invention.

FIG. 6 is a view illustrating an example of a display screen which is displayed on the reproduction device according to Embodiment 1 of the invention.

FIG. 7 is a flowchart illustrating an example of remote simultaneous viewing processing by the reproduction device and the server according to Embodiment 1 of the invention.

FIG. 8 is a flowchart illustrating an example of zapping processing by the reproduction device and the server according to Embodiment 1 of the invention.

FIG. 9 is a view illustrating an example of content reproduction processing by the reproduction device and content transmission processing by the server according to Embodiment 1 of the invention.

FIG. 10 is a view illustrating an example of group zapping list acquisition processing of the reproduction device and group zapping list transmission processing of the server according to Embodiment 1 of the invention.

FIG. 11 is a view illustrating an example of content zapping list acquisition processing of the reproduction device and content zapping list transmission processing of the server according to Embodiment 1 of the invention.

FIG. 12 illustrates an example of a schematic view of a remote simultaneous viewing system according to Embodiment 2 of the invention.

FIG. 13 is a block diagram illustrating an example of a configuration of a main part of a reproduction device according to Embodiment 2 of the invention.

FIG. 14 is a block diagram illustrating an example of a configuration of a main part of a server according to Embodiment 2 of the invention.

FIG. 15 is a view illustrating an example of content management information according to Embodiment 2 of the invention.

FIG. 16 is a view illustrating an example of content reproduction processing by the reproduction device and content transmission processing by the server according to Embodiment 2 of the invention.

FIG. 17 is a block diagram illustrating an example of a configuration of a main part of a reproduction device according to Embodiment 3 of the invention.

FIG. 18 is a block diagram illustrating an example of a configuration of a main part of a server according to Embodiment 3 of the invention.

FIG. 19 is a flowchart illustrating an example of zapping processing by the reproduction device and the server according to Embodiment 3 of the invention.

FIG. 20 is a flowchart illustrating an example of group zapping processing by the server according to Embodiment 3 of the invention.

FIG. 21 is a flowchart illustrating an example of content zapping processing by the server according to Embodiment 3 of the invention.

FIG. 22 is a flowchart illustrating another example of the group zapping processing by the server according to Embodiment 3 of the invention.

FIG. 23 is a block diagram illustrating an example of a configuration of a main part of a server according to Embodiment 4 of the invention.

FIG. 24 is a view illustrating an example of content management information according to Embodiment 4 of the invention.

FIG. 25 is a view illustrating an example of content attribute management information according to Embodiment 4 of the invention.

FIG. 26 is a block diagram illustrating an example of a configuration of a main part of a server according to Embodiment 5 of the invention.

FIG. 27 is a view illustrating an example of group information according to Embodiment 5 of the invention.

FIG. 28 is a block diagram illustrating an example of a configuration of a main part of a server according to Embodiment 6 of the invention.

FIG. 29 is a view illustrating an example of friend management information according to Embodiment 6 of the invention.

### DESCRIPTION OF EMBODIMENTS

### About Remote Simultaneous Viewing System

A remote simultaneous viewing system is a system having means by which all of users who belong to the same group basically view the same content and are able to communicate with each other while each of the users is viewing the content.

The content viewed by a user who belongs to a group is referred to as a group viewing content. Moreover, a user who belongs to a group is referred to as a group member.

In the remote simultaneous viewing system, one or a plurality of users may belong to one group, and there may be a plurality of groups viewing contents of which are the same.

Moreover, in the remote simultaneous viewing system, when a user who belongs to one group transfers to a different group, a content to be viewed by the user is switched from a content viewed by the original group to a content viewed by the different group.

In addition, in the remote simultaneous viewing system, when a user switches a content to be viewed to a different content, basically, a content viewed by another user who belongs to the same group as that of the user is also switched to the different content. That is, a group viewing content is switched. As above, respective users who belong to a group view the same content in principle.

Note that, in a case where a user who is a group member switches to a different content, a content viewed by a different group member may not be switched compulsorily, and the different group member may be urged to switch a viewing content to the different content by notifying, to the different group member, that the user has switched to the different content or the like. In this case, after receiving the aforementioned notification or the like, the different group member determines whether or not to switch to the different content. At this time, there are some cases that a state where all of the group members do not view the same content is caused. In this case, for example, a content which is viewed by the largest number of group members may be the group viewing content. Alternatively, a content viewed by a specific group member may be the group viewing content. Furthermore, in this case, when a group member who does not view the group viewing content does not switch to the viewing content within a predetermined time, this group member may be excluded from the group. A state where group members view the same content may be guaranteed in this manner.

Moreover, in a case where a specific user among group members is authorized to switch a content, when the specific user switches to a different content, a content viewed by another group member may be switched to the different content. In a case where a group member who is not authorized to switch switches to a different content, a content viewed by another group member and a group viewing content may be kept as they are.

In the invention, switching from a content currently viewed to a different content (which is able to be viewed currently) in order by a user is referred to as content zapping. Moreover, transferring from a group currently belonged to a different group in order by a user is referred to group zapping.

### Embodiment 1

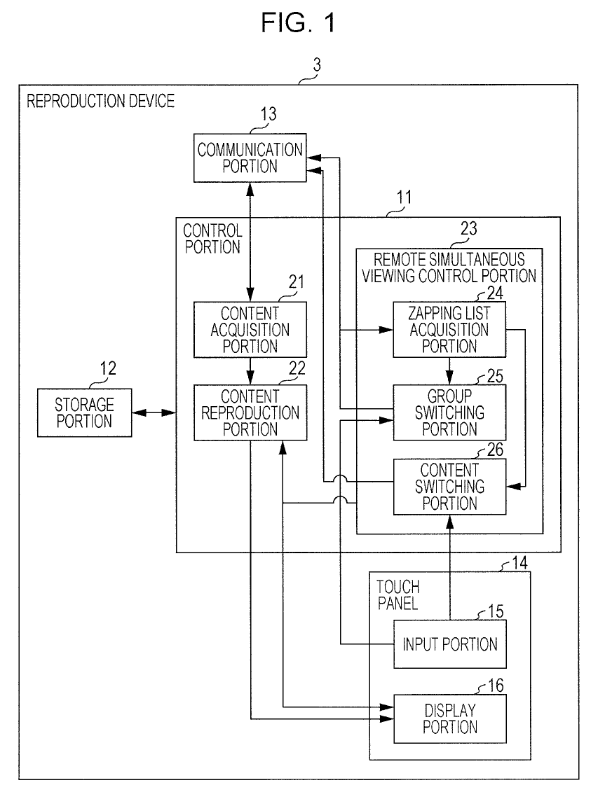

Description will be given for Embodiment 1 according to the invention on the basis of FIG. 1 to FIG. 11 as follows.

### [Overview of Remote Simultaneous Viewing System]

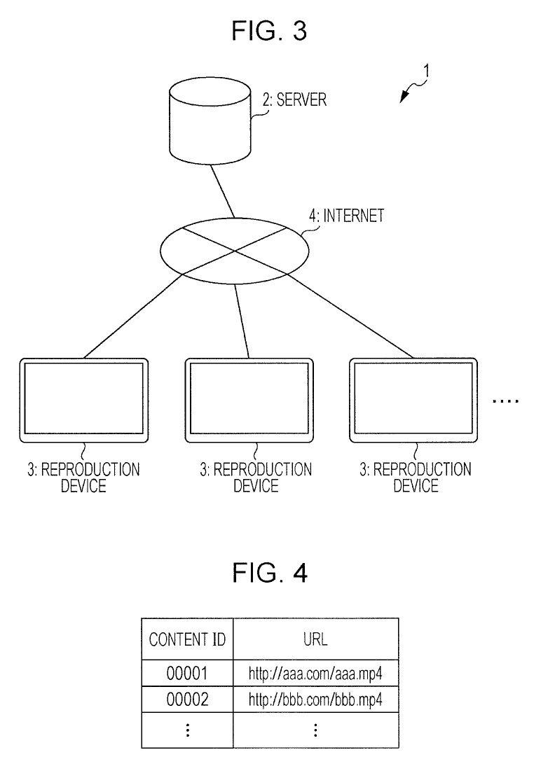

A remote simultaneous viewing system in the present embodiment will be described on the basis of FIG. 3. FIG. 3 illustrates an example of a schematic view of the remote simultaneous viewing system according to Embodiment 1.

As illustrated in FIG. 3, a remote simultaneous viewing system 1 in the present embodiment includes a server 2 and reproduction devices 3, and the server 2 and the reproduction devices 3 are connected via the Internet 4. As illustrated in FIG. 3, the remote simultaneous viewing system 1 includes a plurality of reproduction devices 3. Note that, the remote simultaneous viewing system 1 includes one server 2 in FIG. 3, but may include a plurality of servers 2.

Each of the reproduction devices 3 is a terminal device used by a user, and a device by which a content acquired from the server 2 is reproduced. The reproduction device 3 is realized by a smartphone, a cellular phone, a tablet terminal, a PC, a portable game machine, a television receiver, or the like, for example.

The server 2 is a transmission device that transmits a content to each of the reproduction devices 3. In addition, the server 2 is also a remote simultaneous viewing management device that manages remote simultaneous viewing of each of the reproduction devices 3.

Hereinafter, the server 2 and the reproduction devices 3 which constitute the remote simultaneous viewing system 1 will be described in detail.

### [Configuration of Reproduction Device]

FIG. 1 is a block diagram illustrating an example of a configuration of a main part of the reproduction device 3 according to Embodiment 1. As illustrated in FIG. 1, the reproduction device 3 is provided with a control portion 11, a storage portion 12, a communication portion 13, and a touch panel 14.

The communication portion 13 performs communication with another device such as the server 2 by wireless communication means or wired communication means, and exchanges data in accordance with an instruction of the control portion 11. For example, the communication portion 13 receives content data from the server 2 in accordance with an instruction of the control portion 11.

The touch panel 14 is provided with an input portion 15 having an input function and a display portion 16 having an image displaying function. The input portion 15 is provided so that a user inputs an instruction signal to the reproduction device 3 to operate the reproduction device 3. The display portion 16 displays an image in accordance with an instruction of the control portion 11. Note that, the input portion 15 and the display portion 16 may be provided separately in place of being included in the touch panel 14.

The storage portion 12 stores a program, data, and the like which are referred to by the control portion 11. For example, the storage portion 12 stores remote simultaneous viewing application data, content data, information related to a user, such as a user ID, and the like. Note that, the reproduction device 3 downloads a remote simultaneous viewing application from the server 2 or the like in advance.

The control portion 11 executes a program which is read from the storage portion 12 to a temporary storage portion (not illustrated) to thereby perform various arithmetic operations and integrally control the respective portions provided in the reproduction device 3.

In the present embodiment, the control portion 11 has a configuration in which a content acquisition portion 21, a content reproduction portion (reproduction portion) 22, and a remote simultaneous viewing control portion 23 are provided as functional blocks. Each of the functional blocks of the control portion 11 is able to be realized when a CPU (central processing unit) reads a program stored in a storage device, which is realized by a ROM (read only memory) or the like, to the temporary storage portion, which is realized by a RAM (random access memory) or the like, for execution.

### (Content Acquisition Portion 21)

The content acquisition portion 21 acquires a content from the server 2 via the communication portion 13. Specifically, the content acquisition portion 21 receives a URL of the server 2, which indicates a place in which a content is stored, from the server 2 via the communication portion 13, and then transmits a content request, by which transmission of the content stored in the place indicated by the received URL is requested, to the server 2 via the communication portion 13. Thereafter, in response to the content request, the content acquisition portion 21 acquires content data, which is entity data of the content, from the server 2 via the communication portion 13.

The content acquisition portion 21 outputs the acquired content data to the content reproduction portion 22.

In addition, in the case of receiving a content switching instruction, which includes a content ID of a switching destination, from the remote simultaneous viewing control portion 23, the content acquisition portion 21 transmits the received content switching instruction to the server 2.

### (Content Reproduction Portion 22)

The content reproduction portion 22 receives the content data from the content acquisition portion 21, and reproduces the content on the basis of the received content data. Specifically, the content reproduction portion 22 outputs the content data to the display portion 16, and causes the display portion 16 to display a video.

Though it is assumed, in the present embodiment, that the content data is video data, there is no limitation thereto, and the content data may be video data and audio data, or the content data may be audio data. In this case, the content reproduction portion 22 outputs the audio data to an audio output portion (not illustrated), and causes the audio output portion to output a sound.

### (Remote Simultaneous Viewing Control Portion 23)

The remote simultaneous viewing control portion 23 controls processing related to remote simultaneous viewing in the reproduction device 3. For example, in accordance with an input operation of the user, the remote simultaneous viewing control portion 23 executes start and end of the remote simultaneous viewing application, log-in processing to the remote simultaneous viewing system, processing related to a chat, processing of generation and output of an image which is to be displayed on the display portion 16 at a time of executing the remote simultaneous viewing application, and the like.

The remote simultaneous viewing control portion 23 is provided with a zapping list acquisition portion (list acquisition portion) 24, a group switching portion (switching portion) 25, and a content switching portion 26, as illustrated in FIG. 1.

### (Zapping List Acquisition Portion 24)

The zapping list acquisition portion 24 acquires a group zapping list and a content zapping list from the server 2 via the communication portion 13. In this case, the group zapping list is a list in which respective groups are arrayed in a predetermined order. The reproduction device 3 performs group zapping in accordance with the order of the group zapping list. The content zapping list is a list in which respective contents are arrayed in a predetermined order. The reproduction device 3 performs content zapping in accordance with the order of the content zapping list.

Specifically, the zapping list acquisition portion 24 transmits a group zapping list request, by which transmission of the group zapping list is requested, to the server 2 via the communication portion 13. Subsequently, the zapping list acquisition portion 24 transmits the user ID to the server 2 via the communication portion 13. Then, in response to the group zapping list request, the zapping list acquisition portion 24 acquires the group zapping list from the server 2 via the communication portion 13.

In addition, the zapping list acquisition portion 24 transmits a content zapping list request, by which transmission of the content zapping list is requested, to the server 2 via the communication portion 13. Subsequently, the zapping list acquisition portion 24 transmits the user ID to the server 2 via the communication portion 13. Then, in response to the content zapping list request, the zapping list acquisition portion 24 acquires the content zapping list from the server 2 via the communication portion 13.

Note that, the zapping list acquisition portion 24 may transmit the list request and the user ID at the same time, or transmit the list request with the user ID included therein.

Further, the zapping list acquisition portion 24 transmits the list request in a predetermined case. For example, after group selection after log-in is completed, after content switching, or after group switching, the zapping list acquisition portion 24 may transmit the list request (at least one of the group zapping list request and the content zapping list request). Moreover, in a case where an operation signal indicating switching of a group or a content is received from the user, the zapping list acquisition portion 24 may transmit the list request. In addition, the zapping list acquisition portion 24 may transmit the group zapping list request or the content zapping list request after a predetermined period from acquisition of the group zapping list or the content zapping list. That is, the zapping list acquisition portion 24 may transmit the list request every predetermined period.

### (Group Switching Portion 25)

The group switching portion 25 executes switching of a belonging group of the user on the basis of the group zapping list. Specifically, the group switching portion 25 acquires the group zapping list from the zapping list acquisition portion 24. Then, when an operation signal indicating switching of a group is received from the input portion 15, the group switching portion 25 refers to the group zapping list, and specifies a group ID of a switching destination which is indicated by the received operation signal. The group switching portion 25 transmits the specified group ID (belonging group switching instruction) to the server 2 via the communication portion 13.

For example, when a forwarding button of a group zapping button is pressed twice, the group switching portion 25 transmits a group ID of a second group in the group zapping list.

Note that, a group ID is a code by which a group is identified uniquely.

### (Content Switching Portion 26)

The content switching portion 26 executes switching of a content to be reproduced by the reproduction device 3 (content viewed by a member of the belonging group of the user of the reproduction device 3), on the basis of the content zapping list. Specifically, the content switching portion 26 acquires the content zapping list from the zapping list acquisition portion 24. Then, when an operation signal indicating switching of a content is received from the input portion 15, the content switching portion 26 refers to the content zapping list, and specifies a content ID of a switching destination which is indicated by the received operation signal. The content switching portion 26 transmits the specified content ID to the server 2 via the communication portion 13.

For example, when a forwarding button of a content zapping button is pressed twice, the content switching portion 26 transmits a content ID of a second content in the content zapping list.

Note that, a content ID is a code by which a content is identified uniquely.

### [Configuration of Server]

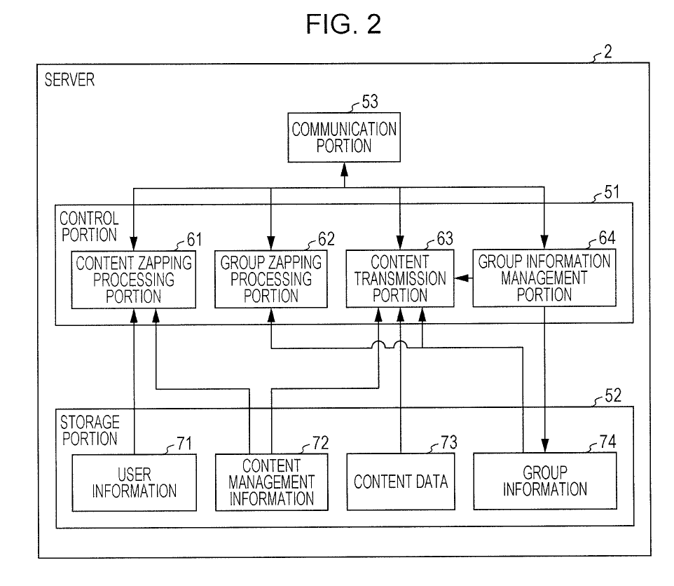

FIG. 2 is a block diagram illustrating an example of a configuration of a main part of the server 2 according to Embodiment 1. As illustrated in FIG. 2, the server 2 is provided with a control portion 51, a storage portion 52, and a communication portion 13.

The communication portion 53 performs communication with another device such as the reproduction device 3 by wireless communication means or wired communication means, and exchanges data in accordance with an instruction of the control portion 51. For example, the communication portion 53 transmits content data to the reproduction device 3 in accordance with an instruction of the control portion 51.

The storage portion 52 stores a program, data, and the like which are referred to by the control portion 51. For example, the storage portion 52 stores user information 71, content management information 72, content data 73, group information 74, and the like.

The user information 71 is information related to a user (information indicating an attribute of a user) of the reproduction device 3 which is included in the remote simultaneous viewing system, and information indicating a user name, an age, an address, a member attribute (paying member or non-paying member), and the like of each user. For example, the user information 71 is information in which information indicating an attribute of a user, such as a user name, an age, an address, and a member attribute, is associated with a user ID. Note that, the user ID is a code by which a user is uniquely identified.

The content management information 72 is information for managing a content which is possible to be transmitted to the reproduction device 3 included in the remote simultaneous viewing system, and information indicating a content name, a storage place (URL), a condition of a user (an attribute of a user) capable of viewing, and the like of each content. For example, the content management information 72 may be information in which a content ID and a URL of a content are associated as illustrated in FIG. 4.

The content data 73 is entity data of a content.

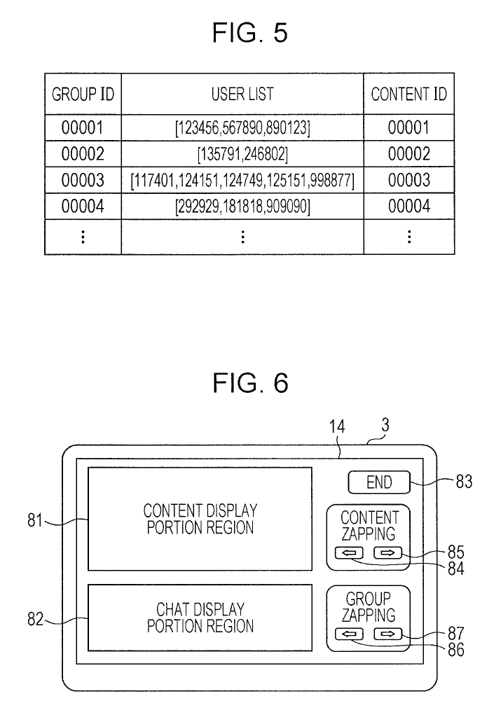

The group information 74 is information related to one or a plurality of groups which are set in the remote simultaneous viewing system, and information indicating a group member, a group viewing content, and the like of each group. For example, the group information 74 is information in which a group ID, a user ID of a corresponding group member, and a content ID of a corresponding group viewing content are associated as illustrated in FIG. 5.

Note that, though an example in which the server 2 is provided with the storage portion 52 is illustrated in FIG. 2, there is no limitation thereto. The storage portion 52 may be a storage device (database) which is provided separately from the server 2. For example, only the content data 73 may be stored in the database which is provided separately from the server 2.

The control portion 51 executes a program which is read from the storage portion 52 to a temporary storage portion (not illustrated) to thereby perform various arithmetic operations and integrally control the respective portions provided in the server 2.

In the present embodiment, the control portion 51 has a configuration in which a content zapping processing portion 61, a group zapping processing portion (list generation portion, switching portion) 62, a content transmission portion 63, and a group information management portion (reception portion, switching portion) 64 are provided as functional blocks. Each of the functional blocks of the control portion 51 is able to be realized when a CPU reads a program stored in a storage device, which is realized by a ROM or the like, to the temporary storage portion, which is realized by a RAM or the like, for execution.

### (Content Zapping Processing Portion 61)

The content zapping processing portion 61 generates a content zapping list and transmits the generated content zapping list to the reproduction device 3. Specifically, when receiving a content zapping list request from the reproduction device 3, the content zapping processing portion 61 reads the user information 71 and the content management information 72 from the storage portion 52. Then, the content zapping processing portion 61 refers to the read user information 71 and content management information 72, and specifies one or more contents which are currently able to be viewed by a user indicated with a user ID which is subsequently received from the aforementioned reproduction device 3. The content zapping processing portion 61 generates a content zapping list in which the specified contents are arrayed. In response to the received content zapping list request, the content zapping processing portion 61 transmits the generated content zapping list to the reproduction device 3, which has transmitted the request, via the communication portion 53.

Note that, the content zapping processing portion 61 may generate a content zapping list in which not only contents which are able to be currently viewed by a user but also all contents which are included in the content management information 72 are arrayed.

Moreover, the content zapping processing portion 61 generates the content zapping list so that contents are arrayed in a predetermined order. The content zapping processing portion 61 may array contents, for example, in an order of content IDs.

### (Group Zapping Processing Portion 62)

The group zapping processing portion 62 generates a group zapping list and transmits the generated group zapping list to the reproduction device 3. Specifically, when receiving a group zapping list request from the reproduction device 3, the group zapping processing portion 62 reads the group information 74 from the storage portion 52. Then, the group zapping processing portion 62 refers to the read group information 74, and specifies one or more different groups viewing contents of which are the same as that of a belonging group of a user indicated with a user ID which is subsequently received from the aforementioned reproduction device 3. The group zapping processing portion 62 generates a group zapping list in which the one or a plurality of specified different groups are arrayed. In response to the received group zapping list request, the group zapping processing portion 62 transmits the generated group zapping list to the reproduction device 3, which has transmitted the request, via the communication portion 53.

Note that, the group zapping processing portion 62 generates the group zapping list so that groups are arrayed in a predetermined order. The group zapping processing portion 62 may array contents, for example, in an order of group IDs or a descending or an ascending order of the number of group members.

### (Content Transmission Portion 63)

The content transmission portion 63 transmits a content to the reproduction device 3. Specifically, when a belonging group change notification (details of which will be described below) is received from the group information management portion 64, the content transmission portion 63 reads the content management information 72 and the group information 74 from the storage portion 52, refers to the read content management information 72 and group information 74, and specifies a URL which indicates a storage destination of a group viewing content of a change destination which is indicated with the notification. Then, the content transmission portion 63 transmits the specified URL to the reproduction device 3 of a user, which is indicated with the notification, via the communication portion 53. When a content request of the content indicated with the URL is received from the reproduction device 3, the content transmission portion 63 reads content data of the content indicated with the URL from the storage portion 52. Then, the content transmission portion 63 transmits the read content data to the reproduction device 3 via the communication portion 53.

Moreover, when a viewing content change notification (details of which will be described below) is received from the group information management portion 64, the content transmission portion 63 reads the content management information 72 and the group information 74 from the storage portion 52, refers to the read content management information 72 and group information 74, and specifies a URL which indicates a storage destination of a changed content indicated with the notification. Then, the content transmission portion 63 transmits the specified URL to each reproduction device 3 of a group member indicated with the notification. When a content request of the content indicated with the URL is received from each reproduction device 3, the content transmission portion 63 reads content data of the content indicated with the URL from the storage portion 52. Then, the content transmission portion 63 transmits the read content data to each reproduction device 3 via the communication portion 53.

### (Group Information Management Portion 64)

The group information management portion 64 generates and updates group information. The group information management portion 64 stores the generated or updated group information 74 in the storage portion 52.

When a user logs in the remote simultaneous viewing system, the group information management portion 64 reads the group information 74 from the storage portion 52, extracts groups, in which the user who has logged in is currently able to participate, from the read group information 74, and generates a group list in which the extracted groups are arrayed. The group information management portion 64 transmits the generated group list to the reproduction device 3 of the user, who has logged in, via the communication portion 53.

In addition, when a group ID is received from the reproduction device 3 via the communication portion 53, the group information management portion 64 changes a belonging group of a user of the reproduction device 3 to a group indicated with the received group ID to thereby update the group information 74. Specifically, the group information management portion 64 reads the group information 74 from the storage portion 52, detects a group ID that is coincident with the group ID which has been received from the group information 74, and associates a user ID of the user of the reproduction device 3 with the detected group ID to thereby update the group information 74. Note that, in a case where the aforementioned user ID is associated with a different group ID in the group information 74 before the update (in a case where the aforementioned user belongs to a different group), the group information management portion 64 deletes the user ID associated with the different group ID.

In other words, the group information management portion 64 is a switching portion which switches, on the basis of a received group ID (belonging group switching instruction), a belonging group of a user of the reproduction device 3 to another group which views a content having the same attribute as that of a content reproduced by the reproduction device 3.

In addition, when a content ID is received from the reproduction device 3 via the communication portion 53, the group information management portion 64 changes a viewing content of a belonging group of a user of the reproduction device 3 to a content indicated with the received content ID to thereby update the group information 74. Specifically, the group information management portion 64 reads the group information 74 from the storage portion 52, detects a group ID of the group, to which the user of the reproduction device 3 belongs, from the group information 74, and changes a content ID associated with the detected group ID to the received content ID to thereby update the group information 74.

In the case of generating or updating the group information 74, the group information management portion 64 notifies the content transmission portion 63 of it. Specifically, in a case where a belonging group of a certain user is changed (including a case where a belonging group is newly set), the group information management portion 64 transmits a belonging group change notification, which indicates that the user has changed the belonging group, to the content transmission portion 63. Moreover, in a case where a group viewing content is changed (including a case where a group viewing content is newly set), the group information management portion 64 transmits a viewing content change notification, which indicates that the group viewing content has been changed, to the content transmission portion 63.

### [Example of Display Screen of Reproduction Device]

Next, an example of a display screen which is displayed on the touch panel 14 (display portion 16) of the reproduction device 3 will be described on the bases of FIG. 6. FIG. 6 is a view illustrating the example of the display screen which is displayed on the reproduction device 3.

The remote simultaneous viewing control portion 23 sets a content display region 81 and a chat display region 82 in a display region of the display portion 16 as illustrated in FIG. 6. In the content display region 81, a content reproduced by the content reproduction portion 22 is displayed. In the chat display region 82, information related to a chat, such as a message uttered by a user himself/herself or a message uttered by a group member, is displayed.

Moreover, the remote simultaneous viewing control portion 23 is provided with an end button 83 of a remote simultaneous viewing application, content zapping buttons 84 and 85, and group zapping buttons 86 and 87 in a region other than the content display region 81 and the chat display region 82. The content zapping button 85 and the group zapping button 87 are forwarding buttons each of which is a button for performing zapping in an order of a list. On the other hand, the content zapping button 84 and the group zapping button 86 are reversing buttons each of which is a button for performing zapping in an order opposite to the order of the list.

### [Processing of Reproduction Device and Server]

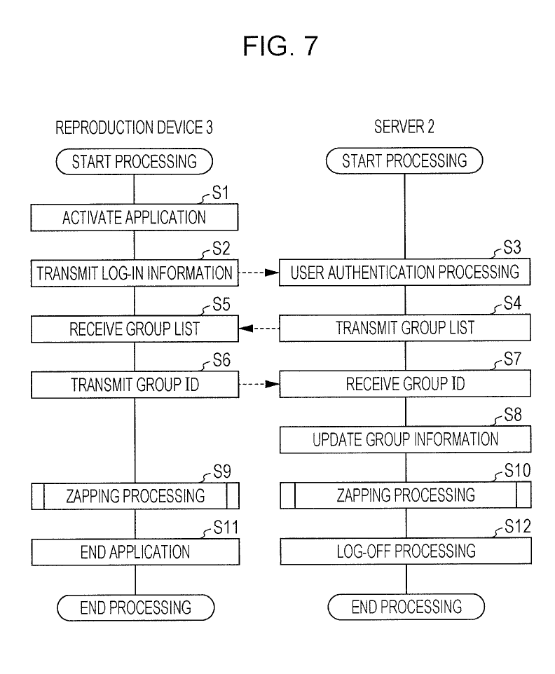

Next, processing of the reproduction device 3 and the server 2 will be described on the basis of FIG. 7 to FIG. 11. FIG. 7 is a view illustrating an example of remote simultaneous viewing processing by the reproduction device 3 and remote simultaneous viewing processing by the server 2, which corresponds to the remote simultaneous viewing processing of the reproduction device 3. Note that, the server 2 executes processing for a plurality of reproduction devices 3 in parallel, but, for convenience of the description, the description will be given in FIG. 7 to FIG. 11 by exemplifying processing mainly for one reproduction device 3.

### (Remote Simultaneous Viewing Processing)

As illustrated in FIG. 7, first, a user performs an activation operation of a remote simultaneous viewing application, and the remote simultaneous viewing control portion 23 of the reproduction device 3 activates the remote simultaneous viewing application (S1). After activating the remote simultaneous viewing application, the remote simultaneous viewing control portion 23 causes the touch panel 14 to display a log-in image for logging in the remote simultaneous viewing system. Here, when the user inputs a user ID, a password, or the like, the remote simultaneous viewing control portion 23 transmits log-in information such as the user ID, the password, or the like, which is for logging in the remote simultaneous viewing system, to the server 2 (S2).

When receiving the log-in information from the reproduction device 3, the control portion 51 of the server 2 executes user authentication processing on the basis of the received log-in information (S3). When the user authentication processing is completed normally, the group information management portion 64 generates a group list where groups in which the authenticated user is currently able to participate are arrayed, and transmits the generated group list to the reproduction device 3 (S4).

The remote simultaneous viewing control portion 23 of the reproduction device 3 receives the group list from the server 2 (S5), and causes the touch panel 14 to display the received group list. Here, when the user selects, from the group list, a group that the user desires to participate in, the remote simultaneous viewing control portion 23 specifies a group ID of the group selected by the user, and transmits the specified group ID to the server 2 (S6).

When receiving the group ID from the reproduction device 3 (S7), the group information management portion 64 of the server 2 causes the user of the reproduction device 3 to belong to the group indicated with the received group ID, and updates the group information 74 (S8).

Then, each of the reproduction device 3 and the server 2 executes zapping processing (S9, S10), and, after finishing the zapping processing, the remote simultaneous viewing control portion 23 of the reproduction device 3 ends the remote simultaneous viewing application (S11), and ends the remote simultaneous viewing processing. On the other hand, after finishing the zapping processing, the control portion 51 of the server 2 executes log-off processing of the reproduction device 3, and ends the remote simultaneous viewing processing by the server 2, which corresponds to the remote simultaneous viewing processing of the reproduction device.

Note that, at S5 and S6, the user may create a new group without selecting a group from the group list. In this case, the reproduction device 3 transmits a group ID of the created group to the server 2.

### (Zapping Processing)

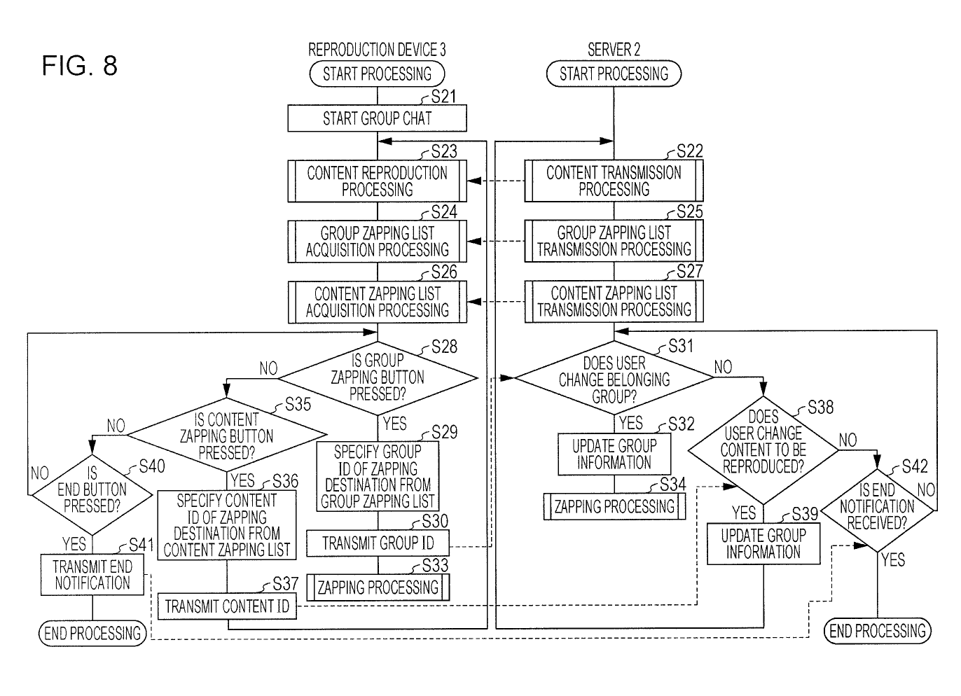

Next, the aforementioned zapping processing (S9, S10) of the reproduction device 3 and the server 2 will be described in detail on the basis of FIG. 8. FIG. 8 is a view illustrating an example of the zapping processing by the reproduction device 3 and the zapping processing by the server 2, which corresponds to the zapping processing of the reproduction device 3.

As illustrated in FIG. 8, the remote simultaneous viewing control portion 23 of the reproduction device 3 executes processing related to a chat, and allows a group chat by the user (S21).

Since the group information management portion 64 of the server 2 updated the group information, the content transmission portion 63 executes content transmission processing (S22). On the other hand, in response to the content transmission processing, the content acquisition portion 21 and the content reproduction portion 22 of the reproduction device 3 execute content reproduction processing (S23).

Next, the zapping list acquisition portion 24 of the reproduction device 3 executes group zapping list acquisition processing (S24) and content zapping list acquisition processing (S26). In response thereto, the group zapping processing portion 62 of the server 2 executes group zapping list transmission processing (S25), and the content zapping processing portion 61 executes content zapping list transmission processing (S27).

Note that, each processing of S22 to S27 will be described in detail below.

After processing of S23, S24, and S26 is completed, the group switching portion 25 of the reproduction device 3 waits until an operation signal which indicates that the group zapping button is pressed is transmitted from the input portion 15 (S28). When the user presses the group zapping button (when the group switching portion 25 receives the operation signal) (YES at S28), the group switching portion 25 specifies a group ID of a zapping destination from a group zapping list (S29). The group switching portion 25 transmits the specified group ID to the server 2 (S30: switching step).

After processing of S22, S25, and S27 is completed, the group information management portion 64 of the server 2 waits until the group ID is transmitted from the reproduction device 3 (S31). When the user changes a belonging group (when the group information management portion 64 receives the group ID from the reproduction device 3) (YES at S31), the group information management portion 64 changes the belonging group of the user, and updates the group information 74 (S32: switching step).

Then, the reproduction device 3 and the server 2 execute the zapping processing again (S33, S34). Note that, since the belonging group of the user of the reproduction device 3 has been changed, in content transmission and reproduction processing at S22 and S23 thereafter, a viewing content of a changed group is transmitted and reproduced.

After processing of S23, S24, and S26 is completed, the content switching portion 26 of the reproduction device 3 waits until an operation signal which indicates that the content zapping button is pressed is transmitted from the input portion 15 (S35). When the user presses the content zapping button (when the content switching portion 26 receives the operation signal) (YES at S35), the content switching portion 26 specifies a content ID of a zapping destination from a content zapping list (S36). The content switching portion 26 transmits the specified content ID to the server 2 (S37).

Moreover, after processing of S22, S25, and S27 is completed, the group information management portion 64 of the server 2 waits until the content ID is transmitted from the reproduction device 3 (S38). When the user changes a content (when the group information management portion 64 receives the content ID from the reproduction device 3) (YES at S38), the group information management portion 64 changes a viewing content of the belonging group of the user, and updates the group information 74 (S32). At this time, since the group viewing content is changed, each content of all group members of the belonging group of the user is to be changed.

Next, the content transmission portion 63 of the server 2 executes content transmission processing (S22) of a content after the change for each of the reproduction devices 3 of all of the group members of the belonging group of the user, which includes the user. In response thereto, each of the reproduction devices 3 of all of the group members of the belonging group of the user executes content reproduction processing (S23) of the content after the change.

Moreover, after processing of S23, S24, and S26 is completed, the remote simultaneous viewing control portion 23 of the reproduction device 3 waits until an operation signal which indicates that the end button is pressed is transmitted from the input portion 15 (S40). When the user presses the end button (when the remote simultaneous viewing control portion 23 receives the operation signal) (YES at S40), the remote simultaneous viewing control portion 23 transmits an end notification of remote simultaneous viewing to the server 2 (S41), and ends the zapping processing.

Moreover, after processing of S22, S25, and S27 is completed, the control portion 51 of the server 2 waits until the end notification is transmitted from the reproduction device 3 (S42). When receiving the end notification from the reproduction device 3 (YES at S42), the control portion 51 ends the zapping processing by the server 2, which corresponds to the zapping processing of the reproduction device 3.

### (Content Transmission Processing and Content Reproduction Processing)

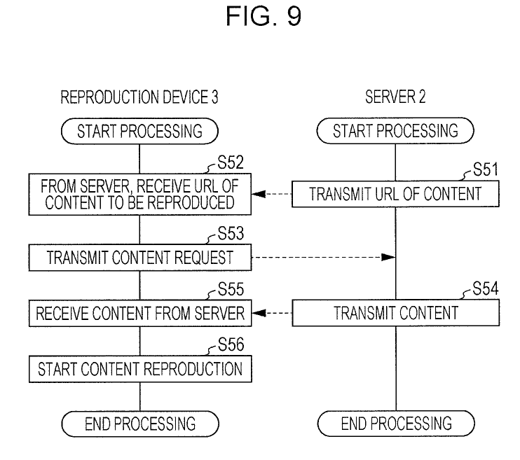

Next, the content transmission processing (S22) of the server 2 and the content reproduction processing (S23) of the reproduction device 3 will be described in detail on the basis of FIG. 9. FIG. 9 is a view illustrating an example of the content transmission processing of the server 2 and the content reproduction processing of the reproduction device 3.

As illustrated in FIG. 9, first, the content transmission portion 63 refers to the group information 74 of the storage portion 52, specifies a viewing content of the belonging group of the user, and transmits a URL of the specified content to the reproduction device 3 (S51).

When receiving the URL of the content to be reproduced from the server 2 (S52), the content acquisition portion 21 of the reproduction device 3 transmits a content request, by which transmission of the content is requested, to the server 2 (S53).

When receiving the content request from the reproduction device 3, the content transmission portion 63 of the server 2 reads content data of the content, which is indicated with the received content request, from the storage portion 52, and transmits the read content data to the reproduction device 3 (S54).

The content acquisition portion 21 of the reproduction device 3 acquires the content data from the server 2 (S55), and the content reproduction portion 22 reproduces the content on the basis of the content data (S56: reproduction step).

### (Group Zapping List Acquisition Processing and Group Zapping List Transmission Processing)

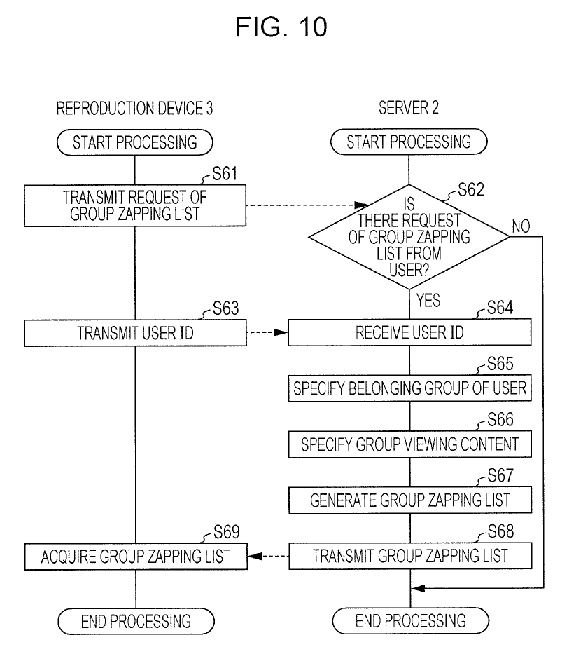

Next, the group zapping list acquisition processing (S24) of the reproduction device 3 and the group zapping list transmission processing (S25) of the server 2 will be described in detail on the basis of FIG. 10. FIG. 10 is a view illustrating an example of the group zapping list acquisition processing of the reproduction device 3 and the group zapping list transmission processing of the server 2.

As illustrated in FIG. 10, first, the zapping list acquisition portion 24 of the reproduction device 3 transmits a group zapping list request to the server 2 (S61). Subsequently, the zapping list acquisition portion 24 transmits the user ID to the server 2 (S62).

The group zapping processing portion 62 of the server 2 waits until the group zapping list request is transmitted from the reproduction device 3 (S63). When receiving the group zapping list request (YES at S63), the group zapping processing portion 62 of the server 2 receives the user ID subsequently transmitted from the reproduction device 3 (S64). The group zapping processing portion 62 refers to the group information 74 of the storage portion 52, and specifies the belonging group of the user on the basis of the received user ID (S65). Then, the group zapping processing portion 62 specifies a viewing content of the specified group (S66). Next, the group zapping processing portion 62 refers to the group information 74, specifies a group which views the same content as the specified viewing content, and generates a group zapping list (S67). The group zapping processing portion 62 transmits the generated group zapping list to the reproduction device 3 (S68).

The zapping list acquisition portion 24 of the reproduction device 3 acquires the group zapping list from the server 2 (S69).

### (Content Zapping List Acquisition Processing and Content Zapping List Transmission Processing)

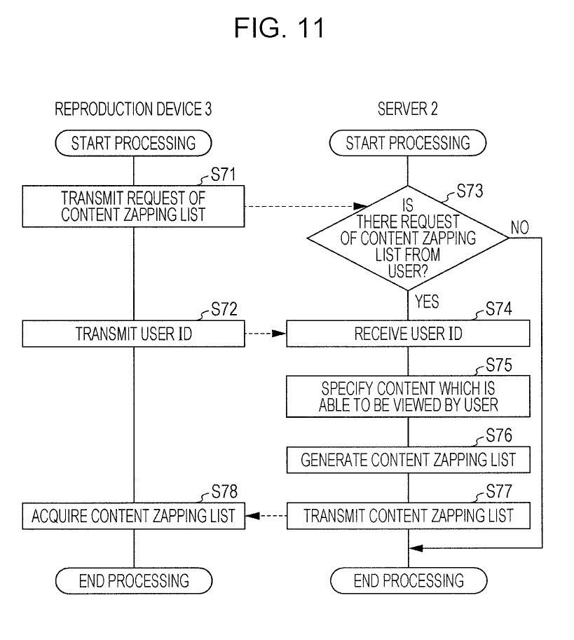

Next, the content zapping list acquisition processing (S26) of the reproduction device 3 and the content zapping list transmission processing (S27) of the server 2 will be described in detail on the basis of FIG. 11. FIG. 11 is a view illustrating an example of the content zapping list acquisition processing of the reproduction device 3 and the content zapping list transmission processing of the server 2.

As illustrated in FIG. 11, first, the zapping list acquisition portion 24 of the reproduction device 3 transmits a content zapping list request to the server 2 (S71). Subsequently, the zapping list acquisition portion 24 transmits the user ID to the server 2 (S72).

The content zapping processing portion 61 of the server 2 waits until the content zapping list request is transmitted from the reproduction device 3 (S73). When receiving the content zapping list request (YES at S73), the content zapping processing portion 61 of the server 2 receives the user ID subsequently transmitted from the reproduction device 3 (S74). The content zapping processing portion 61 refers to the user information 71 and content management information 72 of the storage portion 52, and specifies a content which is able to be viewed by the user (S75). Then, the content zapping processing portion 61 generates a content zapping list in which the specified content is listed (S76). The content zapping processing portion 61 transmits the generated content zapping list to the reproduction device 3 (S77).

The zapping list acquisition portion 24 of the reproduction device 3 acquires the content zapping list from the server 2 (S78).

### Embodiment 2

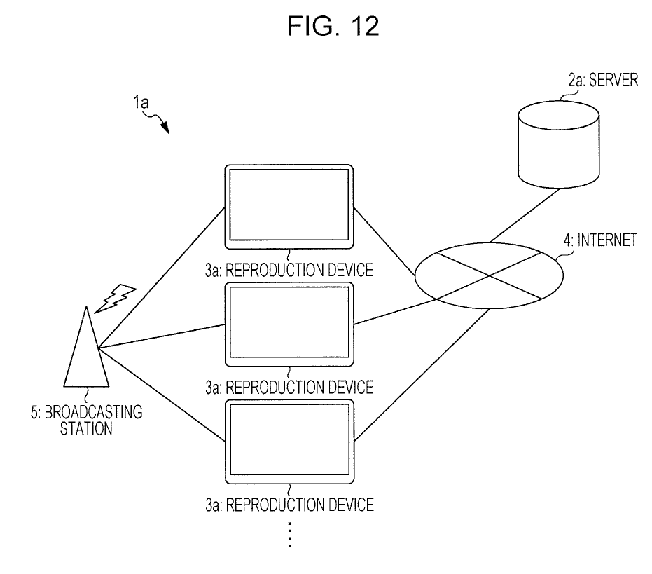

Another embodiment (Embodiment 2) of the invention will be described as follows on the basis of FIG. 12 to FIG. 16. Note that, for convenience of the description, the same reference signs will be assigned to members having the same functions as those of the members described in Embodiment 1 above, and description thereof will be omitted.

Differently from Embodiment 1, in the present embodiment, a reproduction device acquires a content from a broadcasting station in addition to a server. Hereinafter, description will be given mainly for features of Embodiment 2, which are different from those of Embodiment 1.

### [Overview of Remote Simultaneous Viewing System]

A remote simultaneous viewing system in the present embodiment will be described on the basis of FIG. 12. FIG. 12 illustrates an example of a schematic view of the remote simultaneous viewing system in Embodiment 2.

As illustrated in FIG. 12, a remote simultaneous viewing system 1a in the present embodiment includes a server 2a, reproduction devices 3a, and a broadcasting station 5, and the server 2a and the reproduction devices 3a are connected via the Internet 4, and the reproduction devices 3a and the broadcasting station 5 are connected via a broadcast network. Moreover, as illustrated in FIG. 12, the remote simultaneous viewing system 1a includes a plurality of reproduction devices 3a. Note that, the remote simultaneous viewing system 1a includes one server 2a and one broadcasting station 5 in FIG. 12, but may include a plurality of servers 2a and may include a plurality of broadcasting stations 5.

Each of the reproduction devices 3a is a terminal device used by a user, and a device by which a content acquired from the server 2a or the broadcasting station 5 is reproduced. The reproduction device 3a is realized by a smartphone, a cellular phone, a tablet terminal, a PC, a portable game machine, a television receiver, or the like, for example.

The server 2a is a transmission device that transmits a content to each of the reproduction devices 3a. In addition, the server 2a is also a remote simultaneous viewing management device that manages remote simultaneous viewing of each of the reproduction devices 3.

The broadcasting station 5 is a transmission device that transmits a content to each of the reproduction devices 3a.

Hereinafter, the server 2a and the reproduction devices 3a which constitute the remote simultaneous viewing system 1a will be described in detail.

### [Configuration of Reproduction Device]

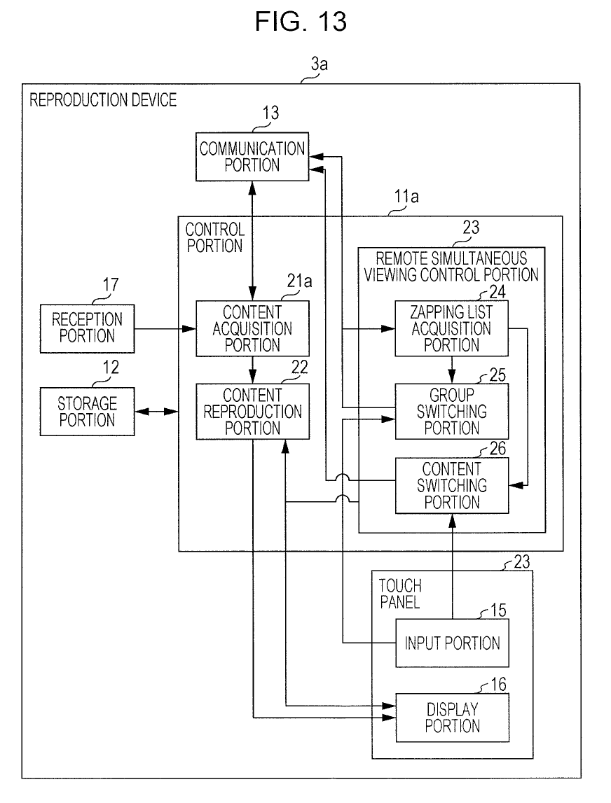

FIG. 13 is a block diagram illustrating an example of a configuration of a main part of the reproduction device 3a according to Embodiment 2. As illustrated in FIG. 13, differently from the reproduction device 3 according to Embodiment 1, the reproduction device 3a according to the present embodiment is further provided with a reception portion 17.

The reception portion 17 receives a broadcast wave transmitted from the broadcasting station 5. The reception portion 17 is a so-called antenna.

A content acquisition portion 21a of a control portion 11a extracts and acquires content data from a broadcast wave, which has a predetermined frequency, among broadcast waves received by the reception portion 17. Note that, the content acquisition portion 21a is able to acquire a content also from the server 2a similarly to the content acquisition portion 21 according to Embodiment 1.

### [Configuration of Server]

FIG. 14 is a block diagram illustrating an example of a configuration of a main part of the server 2a according to Embodiment 2. As illustrated in FIG. 14, compared with the server 2 according to Embodiment 1, a content management information 72a of the server 2a according to the present embodiment, which is stored in a storage portion 52a, is different.

The content management information 72a according to the present embodiment includes a storage place (URL) of a content, or information for content acquisition which is a program ID of a broadcast content. Here, the information for content acquisition is information that the reproduction device 3a uses in order to acquire a content.

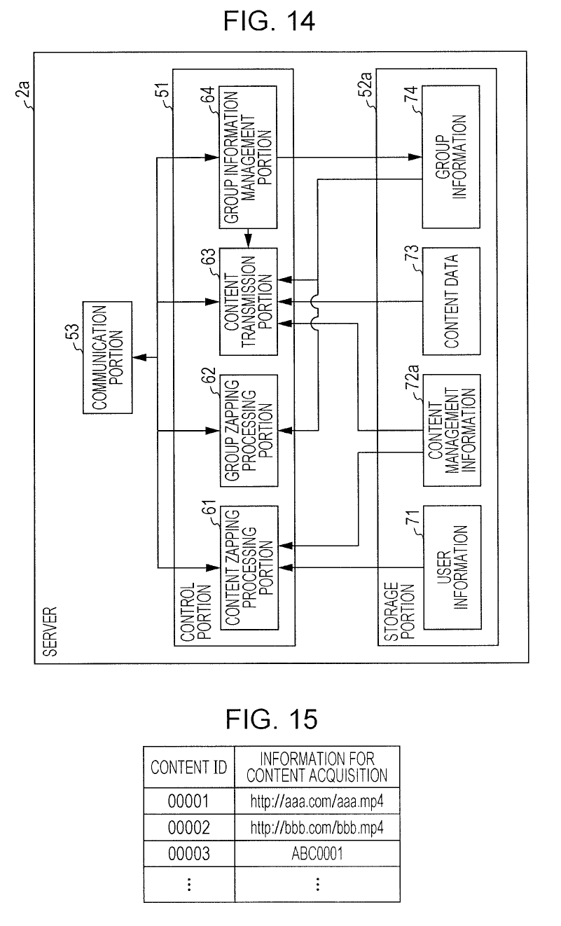

For example, the content management information 72a may be information in which a content ID and information of a content acquisition destination are associated as illustrated in FIG. 15. As illustrated in FIG. 15, in the case of a content (content ID=“0001”, “0002”) distributed by the server 2a, a URL is described as the information of a content acquisition destination. On the other hand, in the case of a content (content ID=“0003”) distributed by the broadcasting station 5, a program ID of a broadcast program is described as the information of a content acquisition destination.

### [Processing of Reproduction Device and Server]

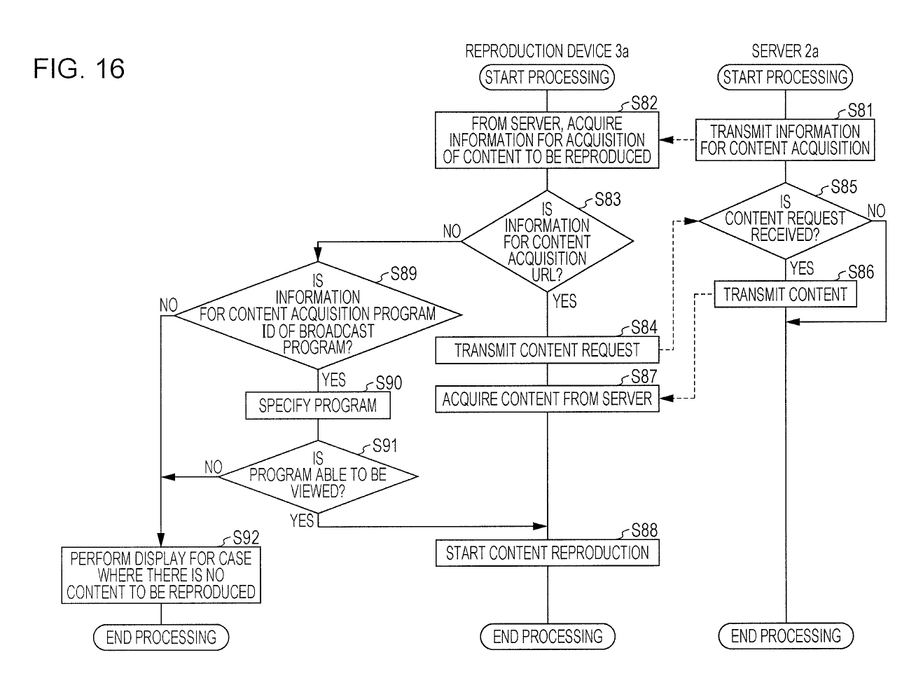

Next, processing of the reproduction device 3a and the server 2a according to the present embodiment will be described. The processing of the reproduction device 3a and the server 2a according to the present embodiment is different from the processing of the reproduction device 3 and the server 2 according to Embodiment 1 only in content reproduction processing and content transmission processing. Thus, the content reproduction processing and the content transmission processing according to the present embodiment will be described on the basis of FIG. 16.

### (Content Transmission Processing and Content Reproduction Processing)

FIG. 16 is a view illustrating an example of the content transmission processing of the server 2a and the content reproduction processing of the reproduction device 3a according to the present embodiment.

As illustrated in FIG. 16, first, the content transmission portion 63 refers to the group information 74 of the storage portion 52, specifies a viewing content of a belonging group of a user, and transmits information for content acquisition of the specified content to the reproduction device 3a (S81).

When receiving the information for content acquisition of the content to be reproduced from the server 2a (S82), the content acquisition portion 21a of the reproduction device 3a judges whether the received information for content acquisition is a URL, a program ID of a broadcast program, or any other information (S83, S89).

In a case where the received information for content acquisition is a URL (YES at S83), the content acquisition portion 21a transmits a content request, by which transmission of a content indicated with the URL is requested, to the server 2a (S84).

The content transmission portion 63 of the server 2a waits until the content request is transmitted from the reproduction device 3a (S85). When receiving the content request from the reproduction device 3a (YES at S85), the content transmission portion 63 reads content data of the content, which is indicated with the received content request, from the storage portion 52a, and transmits the read content data to the reproduction device 3a (S86).

The content acquisition portion 21a of the reproduction device 3a acquires the content data from the server 2a (S87), and the content reproduction portion 22 reproduces the content on the basis of the content data (S88).

On the other hand, in a case where the received information for content acquisition is a program ID of a broadcast program (YES at S89), the content acquisition portion 21a specifies a frequency (program) corresponding to the program ID (S90). Here, the content acquisition portion 21a judges whether or not the reception portion 17 is able to receive a broadcast wave having the specified frequency, that is, whether or not a program is able to be viewed (S91). In a case where the program is able to be viewed (YES at S91), the content acquisition portion 21a extracts content data from the broadcast wave, which has the specified frequency, among broadcast waves received by the reception portion 17. The content reproduction portion 22 reproduces a content on the basis of the content data extracted by the content acquisition portion 21a (S88).

Note that, in a case where the information for content acquisition is neither a URL nor a program ID (NO at S89), or in a case where the program ID of a broadcast program is that of a program which is not able to be viewed (NO at S91), the content acquisition portion 21a is not able to acquire content data, and the content reproduction portion 22 and the remote simultaneous viewing control portion 23 cause the display portion 16 to display an image for a case where there is no content to be reproduced. For example, in the case where there is no content to be reproduced, the content reproduction portion 22 may cause a black image to be displayed in the content display region. Alternatively, in the case where there is no content to be reproduced, the remote simultaneous viewing control portion 23 may cause the chat display region to be displayed on a whole of the screen without providing the content display region.

### Embodiment 3

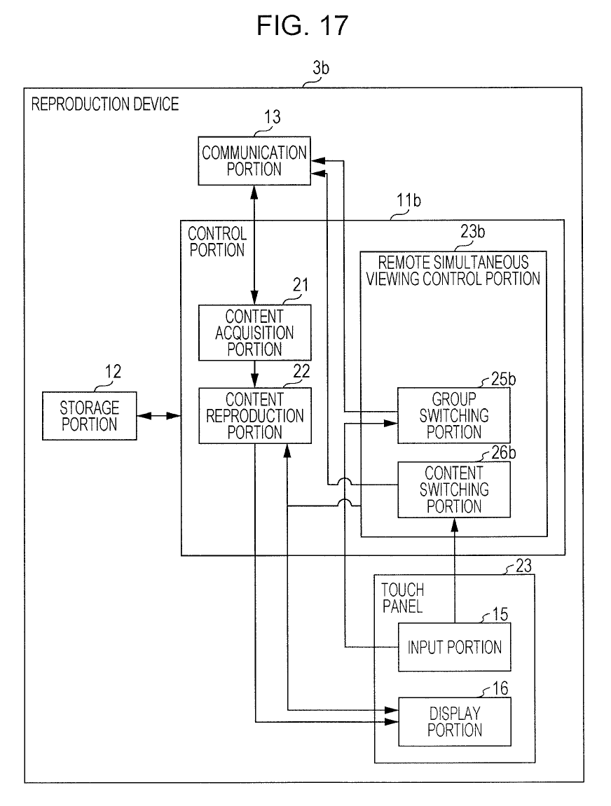

Another embodiment (Embodiment 3) of the invention will be described as follows on the basis of FIG. 17 to FIG. 22. Note that, for convenience of the description, the same reference signs will be assigned to members having the same functions as those of the members described in Embodiment 1 above, and description thereof will be omitted.

Differently from Embodiment 1, in the present embodiment, a server executes zapping processing without transmitting a zapping list to a reproduction device. Hereinafter, description will be given mainly for features of Embodiment 3, which are different from those of Embodiment 1. Note that, the features of the present embodiment are able to be applied not only to Embodiment 1 but also to Embodiment 2.

### [Configuration of Reproduction Device]

FIG. 17 is a block diagram illustrating an example of a configuration of a main part of a reproduction device 3b according to Embodiment 3. As illustrated in FIG. 17, compared with the reproduction device 3 according to Embodiment 1, the reproduction device 3b according to the present embodiment is not provided with the zapping list acquisition portion 24. That is, a remote simultaneous viewing control portion 23b of the reproduction device 3b according to the present embodiment is provided with a group switching portion 25b and a content switching portion 26b.

### (Group Switching Portion 25b)

When an operation signal indicating switching of a group is received from the input portion 15, the group switching portion 25b generates a group zapping instruction (belonging group switching instruction) on the basis of the received operation signal, and transmits the generated group zapping instruction to a server 2b via the communication portion 13. The group zapping instruction is information indicating “forwarding operation for a group n times”, “reversing operation for a group n times”, or the like, for example. Note that, as the group zapping instruction, the group switching portion 25b may transmit the operation signal, which is received from the input portion, as it is to the server 2b.

Moreover, subsequently to the group zapping instruction, the group switching portion 25b transmits a user ID to the server 2b via the communication portion 13. Note that, the group switching portion 25b may transmit the group zapping instruction and the user ID at the same time, or may transmit the group zapping instruction with the user ID included therein.

### (Content Switching Portion 26b)

When an operation signal indicating switching of a content is received from the input portion 15, the content switching portion 26b generates a content zapping instruction on the basis of the received operation signal, and transmits the generated content zapping instruction to the server 2b via the communication portion 13. The content zapping instruction includes information indicating “forwarding operation for a content n times”, “reversing operation for a content n times”, or the like, and the user ID, for example. Note that, as the content zapping instruction, the content switching portion 26b may transmit the operation signal, which is received from the input portion, as it is to the server 2b.

Moreover, subsequently to the content zapping instruction, the content switching portion 26b transmits the user ID to the server 2b via the communication portion 13. Note that, the content switching portion 26b may transmit the content zapping instruction and the user ID at the same time, or may transmit the content zapping instruction with the user ID included therein.

### [Configuration of Server]

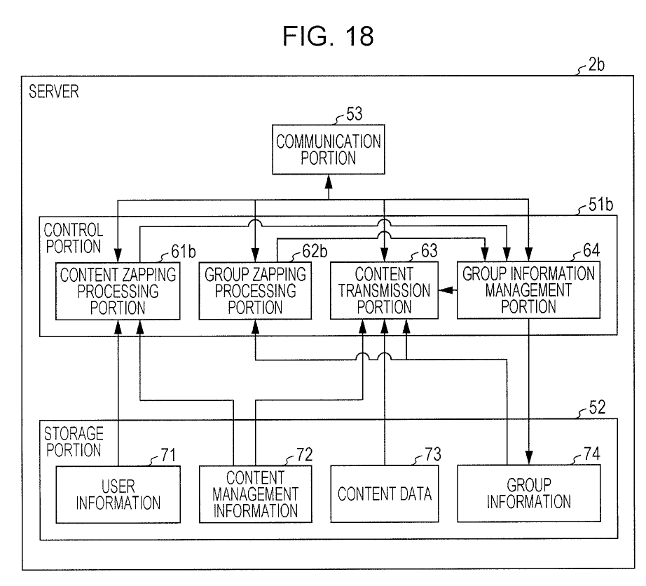

FIG. 18 is a block diagram illustrating an example of a configuration of a main part of the server 2b. As illustrated in FIG. 18, compared with the server 2 according to Embodiment 1, a content zapping processing portion 61b and a group zapping processing portion (reception portion, switching portion, list generation portion) 62b of a control portion 51b of the server 2b according to the present embodiment is different.

### (Content Zapping Processing Portion 61b)

The content zapping processing portion 61b generates a content zapping list, and specifies a content based on a content zapping instruction from the reproduction device in accordance with the generated content zapping list. Specifically, when the content zapping instruction is received from the reproduction device 3b, the content zapping processing portion 61b reads the user information 71 and the content management information 72 from the storage portion 52. Then, the content zapping processing portion 61b refers to the read user information 71 and content management information 72, and specifies one or more contents which are currently able to be viewed by a user indicated with a user ID which is subsequently received from the aforementioned reproduction device 3b. The content zapping processing portion 61b generates a content zapping list in which the specified contents are arrayed. The content zapping processing portion 61b refers to the generated content zapping list to thereby specify a content ID which is indicated by the content zapping instruction received from the reproduction device 3b. The content zapping processing portion 61b outputs the specified content ID to the group information management portion 64.

Note that, the content zapping processing portion 61b may generate a content zapping list in which not only contents which are currently able to be viewed by a user but also all contents which are included in the content management information 72 are arrayed.

Moreover, the content zapping processing portion 61b generates the content zapping list so that contents are arrayed in a predetermined order. The content zapping processing portion 61b may array contents, for example, in an order of content IDs.

### (Group Zapping Processing Portion 62b)

The group zapping processing portion 62b generates a group zapping list, and specifies a group based on a group zapping instruction from the reproduction device in accordance with the generated group zapping list. Specifically, when the group zapping instruction is received from the reproduction device 3b, the group zapping processing portion 62b reads the group information 74 from the storage portion 52. Then, the group zapping processing portion 62b refers to the read group information 74, and specifies one or more different groups viewing contents of which are the same as that of a belonging group of a user indicated with a user ID which is subsequently received from the aforementioned reproduction device 3b. The group zapping processing portion 62b generates a group zapping list in which the one or a plurality of specified different groups are arrayed. The group zapping processing portion 62b refers to the generated group zapping list to thereby specify a group ID which is indicated by the group zapping instruction received from the reproduction device 3b. The group zapping processing portion 62b outputs the specified group ID to the group information management portion 64.

Note that, the group zapping processing portion 62b generates the group zapping list so that groups are arrayed in a predetermined order. The group zapping processing portion 62b may array contents, for example, in an order of group IDs or a descending or an ascending order of the number of group members.

### [Processing of Reproduction Device and Server]

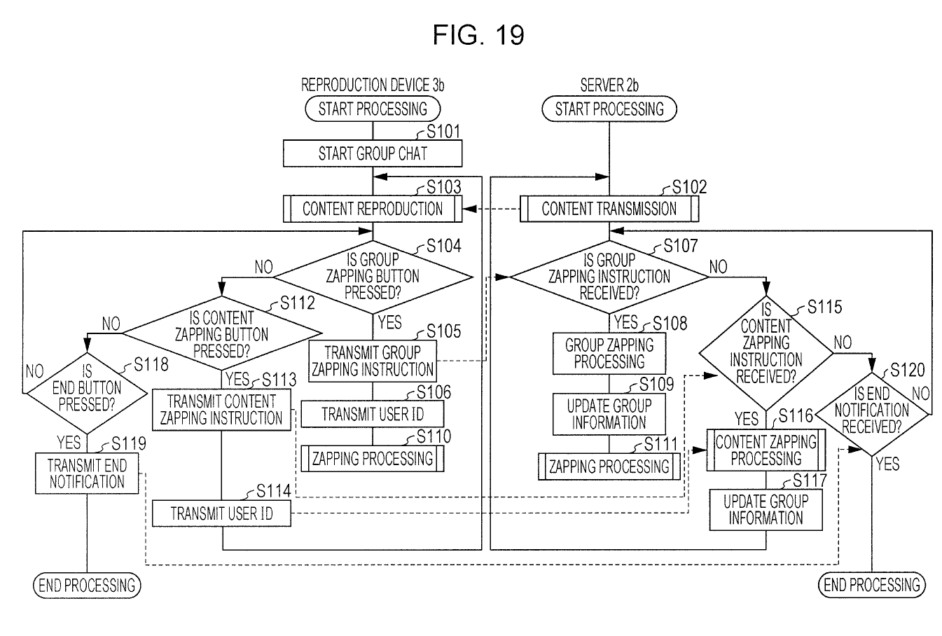

Next, processing of the reproduction device 3b and the server 2b according to the present embodiment will be described. The processing of the reproduction device 3b and the server 2b according to the present embodiment is different from the processing of the reproduction device 3 and the server 2 according to Embodiment 1 in a part of zapping processing. Thus, the zapping processing by the reproduction device 3b and the server 2b according to the present embodiment will be described on the basis of FIG. 19 to FIG. 21.

### (Zapping Processing)

FIG. 19 is a view illustrating an example of zapping processing by the reproduction device 3b and zapping processing by the server 2b, which corresponds to the zapping processing of the reproduction device 3b.

Processing of S101 to S103 illustrated in FIG. 19 is the same as that of S21 to S23 illustrated in FIG. 8.

After processing of S103 is completed, the group switching portion 25b of the reproduction device 3 waits until an operation signal which indicates that the group zapping button is pressed is transmitted from the input portion 15 (S104). When a user presses the group zapping button (when the group switching portion 25b receives the operation signal) (YES at S104), the group switching portion 25b transmits a group zapping instruction based on the received operation signal to the server 2b (S105). Subsequently, the group switching portion 25b transmits a user ID to the server 2b (S106).

After processing of S102 is completed, the group zapping processing portion 62b of the server 2b waits until the group zapping instruction is transmitted from the reproduction device 3b (S107). When the user changes a belonging group (when the group zapping processing portion 62b receives the group zapping instruction from the reproduction device 3b) (YES at S107: reception step), the group zapping processing portion 62b executes group zapping processing (details of which will be described below) (S108). Then, the group information management portion 64 changes the belonging group of the user, and updates the group information 74 (S109).

Then, the reproduction device 3b and the server 2b execute the zapping processing again (S110, S111). Note that, since the belonging group of the user of the reproduction device 3b has been changed, in content transmission and reproduction processing at S102 and S103 thereafter, a viewing content of a changed group is transmitted and reproduced.

After processing of S103 is completed, the content switching portion 26b of the reproduction device 3b waits until an operation signal which indicates that the content zapping button is pressed is transmitted from the input portion 15 (S112). When the user presses the content zapping button (when the content switching portion 26b receives the operation signal) (YES at S112), the content switching portion 26b transmits a content zapping instruction based on the received operation signal to the server 2b (S113). Subsequently, the content switching portion 26b transmits the user ID to the server 2b (S114).

Moreover, after processing of S102 is completed, the content zapping processing portion 61b of the server 2b waits until the content zapping instruction is transmitted from the reproduction device 3b (S115). When the user changes a content (when the content zapping processing portion 61b receives the content zapping instruction from the reproduction device 3b) (YES at S115), the content zapping processing portion 61b executes content zapping processing (details of which will be described below) (S116). Then, the group information management portion 64 changes a viewing content of the belonging group of the user, and updates the group information 74 (S117). At this time, since the group viewing content is changed, each content of all group members of the belonging group of the user is to be changed.

Next, the content transmission portion 63 of the server 2b executes content transmission processing (S102) of a content after the change for each of the reproduction devices 3b of all of the group members of the belonging group of the user, which includes the user. In response thereto, each of the reproduction devices 3b of all of the group members of the belonging group of the user executes content reproduction processing (S103) of the content after the change.

Processing of S118 to S120 illustrated in FIG. 19 is the same as that of S40 to S42 illustrated in FIG. 8.

### (Group Zapping Processing)

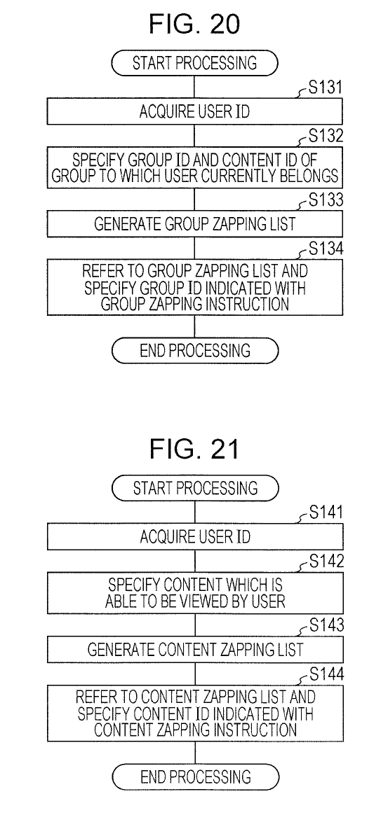

Next, the group zapping processing (S108) of the server 2b will be described in detail on the basis of FIG. 20. FIG. 20 is a view illustrating an example of the group zapping processing of the reproduction device 3b.

As illustrated in FIG. 20, the group zapping processing portion 62b of the server 2 receives the user ID which is transmitted from the reproduction device 3b subsequently to the group zapping instruction (S131). The group zapping processing portion 62b refers to the group information 74 of the storage portion 52, and specifies a belonging group of the user and a viewing content of the specified group on the basis of the received user ID (S132). Next, the group zapping processing portion 62b refers to the group information 74, specifies a group which views the same content as the specified viewing content, and generates a group zapping list (S133). Then, the group zapping processing portion 62b refers to the generated group zapping list, and specifies a group ID which is indicated by the group zapping instruction received from the reproduction device 3b (S134: switching step). The group zapping processing portion 62b outputs the specified group ID to the group information management portion 64.

### (Content Zapping Processing)

Next, the content zapping processing (S116) of the server 2b will be described in detail on the basis of FIG. 21. FIG. 21 is a view illustrating an example of the content zapping processing of the server 2b.

As illustrated in FIG. 21, first, the content zapping processing portion 61b of the server 2b receives the user ID which is transmitted from the reproduction device 3b subsequently to the content zapping instruction (S141). The content zapping processing portion 61b refers to the user information 71 and the content management information 72 of the storage portion 52, and specifies a content which is able to be viewed by the user (S142). Then, the content zapping processing portion 61b generates a content zapping list in which the specified content is listed (S143). Thereafter, the content zapping processing portion 61b refers to the generated content zapping list, and specifies a content ID which is indicated by the content zapping instruction received from the reproduction device 3b (S144). The content zapping processing portion 61b outputs the specified content ID to the group information management portion 64.

### (Modified Example of Group Zapping Processing)

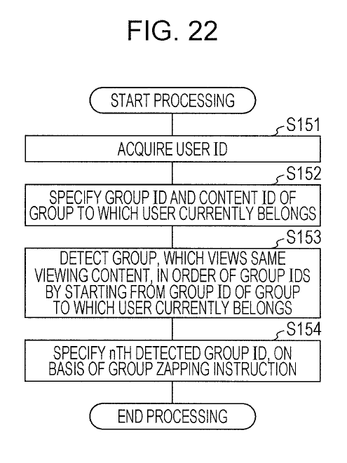

Next, a modified example of the group zapping processing (S108) of the server 2b will be described on the basis of FIG. 22. FIG. 22 is a view illustrating another example of the group zapping processing of the reproduction device 3b. Note that, in the example illustrated in FIG. 22, it is set that the group zapping processing portion 62b has received a group zapping instruction, which indicates “forwarding operation for a group n times”, from the reproduction device 3b.

As illustrated in FIG. 22, the group zapping processing portion 62b of the server 2 receives the user ID which is transmitted from the reproduction device 3b subsequently to the group zapping instruction (S151). The group zapping processing portion 62b refers to the group information 74 of the storage portion 52, and specifies a belonging group of the user and a viewing content of the specified group on the basis of the received user ID (S152). Next, the group zapping processing portion 62b refers to the group information 74, and detects a group, which views the same content as the specified viewing content, in an order of group IDs (ascending order of group IDs) by starting from a group ID of the belonging group of the user (S153). Then, the group zapping processing portion 62b specifies an nth detected group ID on the basis of the group zapping instruction (S134). The group zapping processing portion 62b outputs the specified group ID to the group information management portion 64.

Note that, in a case where the group zapping instruction indicates “reversing operation for a group n times”, the group zapping processing portion 62b may perform detection in a descending order of group IDs by starting from the group ID of the belonging group of the user.

In addition, in a case where a group which views the same content as the viewing content of the belonging group of the user is not detected at all, the group zapping processing portion 62b outputs the group ID of the belonging group of the user to the group information management portion 64.

### Embodiment 4

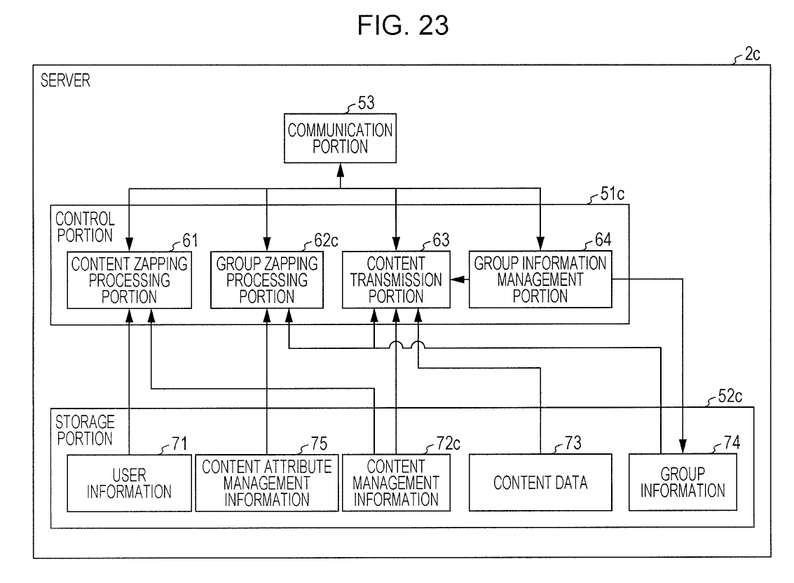

Another embodiment (Embodiment 4) of the invention will be described as follows on the basis of FIG. 23 to FIG. 25. Note that, for convenience of the description, the same reference signs will be assigned to members having the same functions as those of the members described in Embodiment 1 above, and description thereof will be omitted.

Differently from Embodiment 1, in the present embodiment, a group zapping processing portion includes a group, which views a content having the same attribute as that of a viewing content of a belonging group of a user of a reproduction device, in a zapping list. Hereinafter, description will be given mainly for features of Embodiment 4, which are different from those of Embodiment 1. Note that, the features of the present embodiment are able to be applied not only to Embodiment 1 but also to Embodiment 2 and Embodiment 3.

### [Configuration of Server]

FIG. 23 is a block diagram illustrating an example of a configuration of a main part of the server 2c according to Embodiment 4. As illustrated in FIG. 23, compared with the server 2 according to Embodiment 1, a group zapping processing portion (switching portion, list generation portion) 62c of a control portion 51c of the server 2c according to the present embodiment is different. In addition, content management information 72c stored in a storage portion 52c is different, and content attribute management information 75 is further stored in the storage portion 52c.

### (Content Management Information 72c)

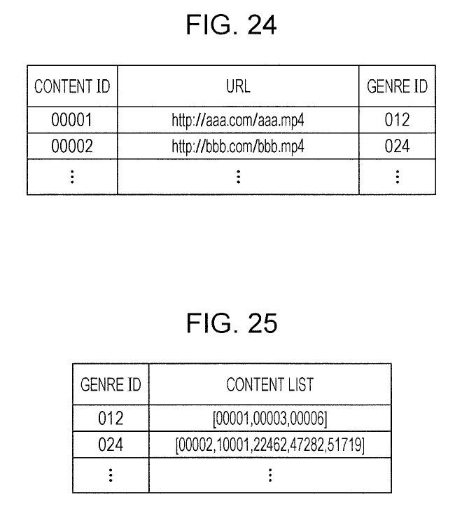

The content management information 72c is information for managing a content which is possible to be transmitted to the reproduction device 3 included in the remote simultaneous viewing system, and information further including content attribute information indicating an attribute of a content in addition to information indicating a content name, a storage place (URL), a condition of a user (an attribute of a user) capable of viewing, and the like of each content. The attribute of a content is, for example, a genre of a content. Examples of the genre of a content include “news”, “a drama”, “sports”, “a variety show”, and the like. The “sports” may be fractionated by sorting contents in accordance with “baseball”, “soccer”, and the like. For example, the content management information 72c may be information in which a content ID, a URL of a content, and a genre ID indicating a genre of the content are associated as illustrated in FIG. 24.

### (Content Attribute Management Information 75)

The content attribute management information 75 is information indicating contents each of which belongs to a genre. For example, the content attribute management information 75 may be information in which a genre ID and a content ID of a content which is in a genre indicated with the genre ID are associated as illustrated in FIG. 25.

### (Group Zapping Processing Portion 62c)

The group zapping processing portion 62c refers to the group information 74 and the content attribute management information 75, specifies a group which views a content having the same attribute as that of a viewing content of a belonging group of a user, and generates a group zapping list.

Specifically, when a group zapping list request is received from the reproduction device 3, the group zapping processing portion 62c reads the group information 74 from the storage portion 52c. Then, the group zapping processing portion 62c refers to the read group information 74, and specifies the belonging group of the user indicated with a user ID which is subsequently received from the aforementioned reproduction device 3, and the viewing content of the belonging group.

Thereafter, the group zapping processing portion 62c reads the content attribute management information 75 from the storage portion 52c, refers to the read content attribute management information 75, and specifies a content which has the same attribute (which is in the same genre) as that of the specified content. For example, in an example illustrated in FIG. 24 and FIG. 25, in a case where the content ID of the viewing content of the belonging group of the user is “00001”, the group zapping processing portion 62c specifies each of “00001”, “00003”, and “00006” as a content ID of a content having the same attribute.

Next, the group zapping processing portion 62c specifies a group which views the specified content having the same attribute. That is, in the example described above, the group zapping processing portion 62c specifies a group a viewing content of which is a content whose content ID is any one of “00001”, “00003”, and “00006”.

The group zapping processing portion 62c generates a group zapping list in which one or a plurality of different groups which have been specified are arrayed. In response to the received group zapping list request, the group zapping processing portion 62c transmits the generated group zapping list to the reproduction device 3, which has transmitted the request, via the communication portion 53.

### Embodiment 5

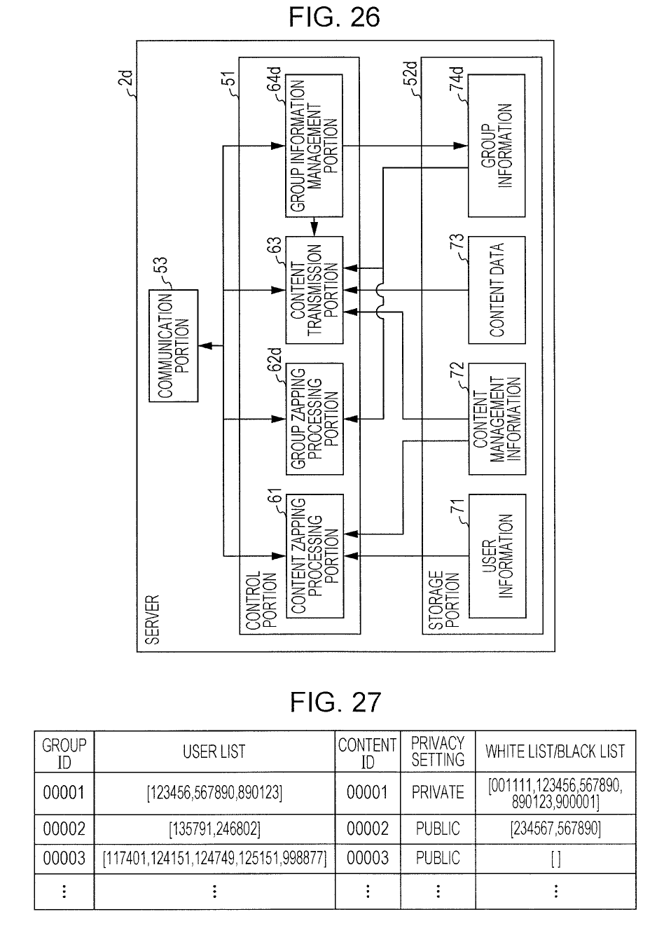

Another embodiment (Embodiment 5) of the invention will be described as follows on the basis of FIG. 26 and FIG. 27. Note that, for convenience of the description, the same reference signs will be assigned to members having the same functions as those of the members described in Embodiment 1 above, and description thereof will be omitted.

Differently from Embodiment 1, in the present embodiment, setting of public/private is provided for each group. Hereinafter, description will be given mainly for features of Embodiment 5, which are different from those of Embodiment 1. Note that, the features of the present embodiment are able to be applied not only to Embodiment 1 but also to Embodiment 2 to Embodiment 4.

### [Configuration of Server]

FIG. 26 is a block diagram illustrating an example of a configuration of a main part of the server 2d according to Embodiment 5. As illustrated in FIG. 26, compared with the server 2 according to Embodiment 1, a group zapping processing portion 62d and a group information management portion (participation propriety setting portion) 64d of a control portion 51d of the server 2d according to the present embodiment is different. In addition, group information 74d stored in a storage portion 52d is different.

### (Group Information 74d)

The group information 74d is information related to one or a plurality of groups which are set in the remote simultaneous viewing system, and information which indicates a group member, a group viewing content, and the like in each of the groups. Furthermore, in the present embodiment, in addition to such information, the group information 74d includes information which indicates a user who is allowed to participate in a group or a user who is not allowed to participate in a group. For example, as illustrated in FIG. 27, the group information 74d is information in which a group ID, a user ID of a member of the group, a content ID of a viewing content of the group, privacy setting of the group, and a white list of a user who is allowed to participate in the group or a black list of a user who is not allowed to participate are associated.

Here, a group privacy setting illustrated in FIG. 27 of which is “private” is not opened to the public in principle, and opened only to a user on the list. That is, in an example illustrated in FIG. 27, a group whose group ID is “00001” allows only a user on the list to participate therein.

Moreover, a group privacy setting illustrated in FIG. 27 of which is “public” is opened to the public in principle, and not opened only to a user on the list. That is, in the example illustrated in FIG. 27, a group whose group ID is “00002” does not allow only a user on the list to participate therein.

### (Group Information Management Portion 64d)

The group information management portion 64d sets privacy setting of each group (whether the group is “private” or “public”) and a white list or a black list in accordance with an instruction from a user (reproduction device 3). That is, the group information management portion 64d sets, for each group, a user who is allowed to participate or not allowed to participate.

### (Group Zapping Processing Portion 62d)

The group zapping processing portion 62d refers to the group information 74d, and generates a group zapping list by excluding, from groups which view the same content as a viewing content of a belonging group of a user, a group which does not allow the user to participate therein.

Specifically, when a group zapping list request is received from the reproduction device 3, the group zapping processing portion 62d reads the group information 74d from the storage portion 52d. Then, the group zapping processing portion 62d refers to the read group information 74d, and specifies the belonging group of the user indicated with a user ID which is subsequently received from the aforementioned reproduction device 3 and the viewing content of the belonging group. Thereafter, the group zapping processing portion 62d specifies a group which views the specified content.

Here, in a case where, when referring to the group information 74d, there is a group, in which the user is not allowed to participate, among specified groups, the group zapping processing portion 62d excludes the group which does not allow participation from the specified groups. Then, the group zapping processing portion 62d generates a group zapping list in which a remaining group is listed. In response to the received group zapping list request, the group zapping processing portion 62d transmits the generated group zapping list to the reproduction device 3, which has transmitted the request, via the communication portion 53.

### Embodiment 6

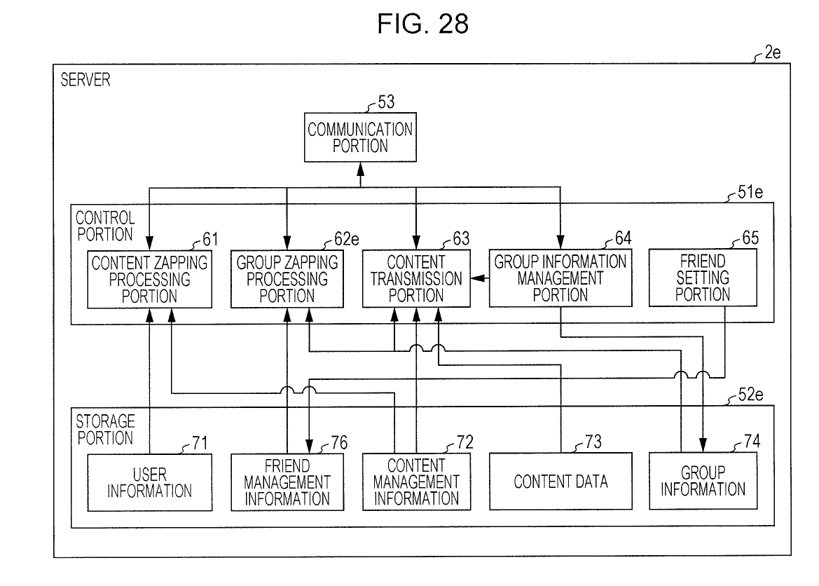

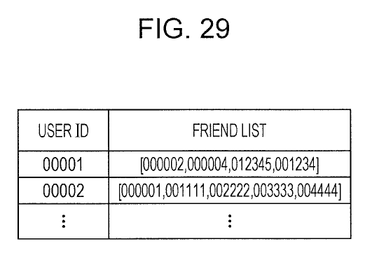

Another embodiment (Embodiment 6) of the invention will be described as follows on the basis of FIG. 28 and FIG. 29. Note that, for convenience of the description, the same reference signs will be assigned to members having the same functions as those of the members described in Embodiment 1 above, and description thereof will be omitted.

Differently from Embodiment 1, in the present embodiment, friend setting is allowed between users. Hereinafter, description will be given mainly for features of Embodiment 6, which are different from those of Embodiment 1. Note that, the features of the present embodiment are able to be applied not only to Embodiment 1 but also to Embodiment 2 to Embodiment 5.

### [Configuration of Server]

FIG. 28 is a block diagram illustrating an example of a configuration of a main part of the server 2e according to Embodiment 6. As illustrated in FIG. 28, compared with the server 2 according to Embodiment 1, a group zapping processing portion 62e of a control portion 51e of the server 2e according to the present embodiment is different. Moreover, the control portion 51e is further provided with a friend setting portion 65. In addition, friend management information 76 is further stored in the storage portion 52e.

### (Friend Management Information 76)

The friend management information 76 is information for managing a friend of a user, and information which indicates, for each user, a user who is set as a friend by the user. For example, the friend management information 76 may be information in which a user ID and a user ID of a user who is a friend of a user indicated with the user ID are associated as illustrated in FIG. 29. Note that, a friend means a user who has a predetermined relation with a certain user.

### (Friend Setting Portion 65)

The friend setting portion 65 sets, on the basis of an instruction from a user (reproduction device 3), a friend of the user. That is, the friend setting portion 65 sets, for each user, a friend which indicates that the user and another user have a predetermined relation.

### (Group Zapping Processing Portion 62e)

The group zapping processing portion 62e refers to the group information 74 and the friend management information 76, specifies a group which views the same content as a viewing content of a belonging group of a user and to which another user who has a relation of a friend with the user belongs, and generates a group zapping list.

Specifically, when a group zapping list request is received from the reproduction device 3, the group zapping processing portion 62e reads the group information 74 from the storage portion 52e. Then, the group zapping processing portion 62e refers to the read group information 74, and specifies the belonging group of the user indicated with a user ID which is subsequently received from the aforementioned reproduction device 3 and the viewing content of the belonging group. Thereafter, the group zapping processing portion 62e specifies groups which view the specified content.

Here, the group zapping processing portion 62e refers to the group information 74 and the friend management information 76, and extracts a group, to which a friend of the user belongs, from the specified groups. Then, the group zapping processing portion 62e generates a group zapping list in which the extracted group is listed. In response to the received group zapping list request, the group zapping processing portion 62e transmits the generated group zapping list to the reproduction device 3, which has transmitted the request, via the communication portion 53.

Note that, the group zapping processing portion 62e generates the group zapping list so that groups are arrayed in a predetermined order. The group zapping processing portion 62e may array contents, for example, in an order of group IDs, a descending or an ascending order of the number of group members, or a descending or an ascending order of the number of friends included in group members.

### Modified Example

In each of the aforementioned embodiments, it is set that all of group members view the same content in principle in the remote simultaneous viewing system. However, there is no limitation thereto, and, even in a case where a certain user who is a group member switches to another content, and the certain user views the content which is different from a group viewing content, the certain user may not be excluded from membership and may be kept as a group member of the group. That is, group members may view different contents.

Even in this case, a main topic of communication of the group members is related to the group viewing content, and it is assumed that the certain user enjoys communication in the group while being conscious of viewing the content different from those of other group members.

Here, in a case where the certain user who views the content different from those of the other group members performs group zapping, a belonging group of the user may be sequentially switched to another group a main topic of which is a content having the same attribute as that of a content which is set as a main topic of communication by the certain user.

### <Implementation Example by Software>

Control blocks (particularly, the control portions 51, 51b, 51c, 51d, and 51e, and the control portions 11 and 11a) of the servers 2, 2a, 2b, 2c, 2d, and 2e and the reproduction devices 3, 3a, and 3b may be implemented by a logical circuit (hardware) formed on, for example, an integrated circuit (IC chip) or may be implemented by software by using a CPU (Central Processing Unit).

In the latter case, each of the servers 2, 2a, 2b, 2c, 2d, and 2e and the reproduction devices 3, 3a, and 3b includes: a CPU for executing commands of a program which is software for implementing each function; a ROM (Read Only Memory) or a storage device (each of which is referred to as a “recording medium”) in which the program and various kinds of data are recorded so as to be readable by a computer (or CPU); a RAM (Random Access Memory) for expanding the program; and the like. Then, the object of the invention is achieved when the computer (or CPU) reads the program from the recording medium and executes it. As the recording medium, “tangible medium which is not temporary” such as, for example, a tape, a disk, a card, a semiconductor memory, or a programmable logical circuit can be used. Furthermore, the program may be supplied to the computer via any transmission medium capable of transmitting the program (such as a communication network or a broadcast wave). Note that, the invention is also able to be implemented in a form of a data signal embedded in a carrier wave in which the program is embodied by electronic transmission.

### [Overview]

A reproduction device according to an aspect 1 of the invention is a reproduction device that is included in a remote simultaneous viewing system in which there are a plurality of groups, to each of which one or a plurality of users belong, and users who belong to a same group view a same content, including: a reproduction portion (content reproduction portion 22) that reproduces a content; and a switching portion (group switching portion 25) that switches a belonging group of a user of the reproduction device to a different group that views a content having a same attribute as that of the content reproduced by the reproduction portion.

According to the aforementioned configuration, since the switching portion performs switching to the different group that views the content having the same attribute as that of the reproduced content, an effect that the user is able to switch to the different group that views the content having the same attribute as that of a viewing content is achieved.

It can be considered here that there is a possibility that a different user of the different group that views the content having the same attribute as that of the content viewed by the user of the reproduction device has an interest or a taste which is the same as or similar to that of the user of the reproduction device or has information related to the content viewed by the user. Thus, as in the aforementioned configuration, when the switching portion performs switching to the different group that views the content having the same attribute, the user of the reproduction device is able to participate in a group to which a different user who has the same or a similar interest or taste or a different user who has the information related to the content viewed by the user belongs.

A reproduction device according to an aspect 2 of the invention may further include, in the aspect 1, a list acquisition portion (zapping list acquisition portion 24) that acquires a list in which a plurality of different groups are arrayed in a predetermined order, in which the switching portion may perform switching to a different group in accordance with the order of the list acquired by the list acquisition portion.

According to the aforementioned configuration, the switching portion is able to perform switching to a different group in order in accordance with the order of the list or a reverse order of the list. Thus, in a case where there are a plurality of different groups, the user of the reproduction device is able to switch the belonging group to a different group in order in accordance with the predetermined order.

A reproduction device according to an aspect 3 of the invention may further include, in the aspect 1 or 2, a content acquisition portion (content acquisition portion 21, 21a) that acquires a content from at least one of a broadcasting station, which is connected to the reproduction device via a broadcast network, and a transmission device which is connected to the reproduction device via the Internet, in which the reproduction portion may reproduce the content acquired by the content acquisition portion.

According to the aforementioned configuration, the reproduction portion reproduces at least one content of a content transmitted from the broadcasting station and a content on the Internet, which is transmitted from the transmission device. Thus, the user of the reproduction device is able to view at least one content of the content transmitted from the broadcasting station and the content on the Internet, which is transmitted from the transmission device.

A remote simultaneous viewing management device according to an aspect 4 of the invention is a remote simultaneous viewing management device that is included in a remote simultaneous viewing system in which there are a plurality of groups, to each of which one or a plurality of users belong, and users who belong to a same group view a same content, including: a reception portion (group information management portion 64, group zapping processing portion 62b) that receives a belonging group switching instruction from a reproduction device of a user; and a switching portion (group information management portion 64, group zapping processing portion 62b) that switches a belonging group of the user to a different group, which views a content having a same attribute as that of a content reproduced by the reproduction device, on a basis of the belonging group switching instruction received by the reception portion.

According to the aforementioned configuration, since the switching portion performs switching to the different group that views the content having the same attribute as that of the content reproduced by the reproduction device, an effect that the remote simultaneous viewing management device is able to allow the user of the reproduction device to switch to the different group that views the content having the same attribute as that of a viewing content is achieved.

It can be considered here that there is a possibility that a different user of the different group that views the content having the same attribute as that of the content viewed by the user of the reproduction device has an interest or a taste which is the same as or similar to that of the user of the reproduction device or has information related to the content viewed by the user. Thus, as in the aforementioned configuration, when the switching portion performs switching to the different group that views the content having the same attribute, the remote simultaneous viewing management device is able to allow the user of the reproduction device to participate in a group to which a different user who has the same or a similar interest or taste or a different user who has the information related to the content viewed by the user belongs.

A remote simultaneous viewing management device according to an aspect 5 of the invention may further include, in the aspect 4, a list generation portion (group zapping processing portion 62) that generates a list in which a plurality of different groups are arrayed in a predetermined order, in which the switching portion may perform switching to a different group in accordance with the order of the list generated by the list generation portion.

According to the aforementioned configuration, the switching portion is able to perform switching to a different group in order in accordance with the order of the list or a reverse order of the list. Thus, in a case where there are a plurality of different groups, the remote simultaneous viewing management device is able to allow the user of the reproduction device to switch the belonging group to a different group in order in accordance with the predetermined order.

A remote simultaneous viewing management device according to an aspect 6 of the invention may further include, in the aspect 4 or 5, a participation propriety setting portion (group information management portion 64d) that, for each group, sets a user who is allowed to participate or not allowed to participate, in which the switching portion may exclude, among the different groups, a group, in which the user of the reproduction device is not allowed to participate, from groups of a switching destination.

According to the aforementioned configuration, the switching portion excludes the group, in which the user of the reproduction device is not allowed to participate, from the groups of a switching destination. Thus, the remote simultaneous viewing management device never presents the group, in which the user of the reproduction device is not allowed to participate, to the user of the reproduction device as a group of a switching destination. Thus, the remote simultaneous viewing management device is able to improve convenience of the user of the reproduction device.

A remote simultaneous viewing management device according to an aspect 7 of the invention may further include, in any one of the aspects 4 to 6, a friend setting portion (friend setting portion 65) that, for each user, sets a friend indicating that the user and another user have a predetermined relation, in which the switching portion switches the belonging group of the user to a different group which views a content having the same attribute of that of the content reproduced by the reproduction device and to which another user who has the relation of the friend with the user of the reproduction device belongs.

According to the aforementioned configuration, the switching portion switches the belonging group of the user to the different group which views the content having the same attribute of that of the content reproduced by the reproduction device and to which another user who has the relation of the friend with the user of the reproduction device belongs. Thus, the remote simultaneous viewing management device is able to allow the user of the reproduction device to easily select a group, to which the friend belongs, by limiting groups of a switching destination to a group to which the friend belongs.

A remote simultaneous viewing system according to an aspect 8 of the invention may include the reproduction device according to any one of the aspects 1 to 3 and the remote simultaneous viewing management device according to any one of the aspects 4 to 7.

A control method of a reproduction device according to an aspect 9 of the invention is a control method of a reproduction device that is included in a remote simultaneous viewing system in which there are a plurality of groups, to each of which one or a plurality of users belong, and users who belong to a same group view a same content, the control method including: a reproducing step of reproducing a content; and a switching step of switching a belonging group of a user of the reproduction device to a different group that views a content having a same attribute as that of the content reproduced at the reproducing step.

According to the aforementioned configuration, an effect similar to that of the reproduction device according to the aspect 1 is achieved.

A control method of a remote simultaneous viewing management device according to an aspect 10 of the invention is a control method of a remote simultaneous viewing management device that is included in a remote simultaneous viewing system in which there are a plurality of groups, to each of which one or a plurality of users belong, and users who belong to a same group view a same content, the control method including: a receiving step of receiving a belonging group switching instruction from a reproduction device of a user; and a switching step of switching a belonging group of the user to a different group, which views a content having a same attribute as that of a content reproduced by the reproduction device, on a basis of the belonging group switching instruction received at the receiving step.

According to the aforementioned configuration, an effect similar to that of the remote simultaneous viewing management device according to the aspect 4 is achieved.

A reproduction device according to an aspect 11 of the invention may further include, in the aspect 2, an input portion by which an operation instruction from the user is received, in which the list acquisition portion may acquire the list in a case where the input portion receives an operation instruction that instructs switching of a group.

In a reproduction device according to an aspect 12 of the invention, in the aspect 2, the list acquisition portion may acquire the list every predetermined period.

The reproduction device or the remote simultaneous viewing management device according to each aspect of the invention may be implemented by a computer. In this case, a control program of the reproduction device or the remote simultaneous viewing management device, which implements the reproduction device or the remote simultaneous viewing management device in the computer by causing the computer to operate as each portion provided in the reproduction device or the remote simultaneous viewing management device, and a computer readable recording medium which records the control program therein are included in the scope of the invention.

The invention is not limited to each of the embodiments described above, and may be modified in various manners within the scope of the claims and an embodiment achieved by appropriately combining technical means disclosed in each of different embodiments is also encompassed in the technical scope of the invention. Further, by combining the technical means disclosed in each of the embodiments, a new technical feature may be formed.

### INDUSTRIAL APPLICABILITY

The invention is able to be used for a reproduction device that reproduces a content and a transmission device that transmits the content to the reproduction device.

### REFERENCE SIGNS LIST

1, 1a remote simultaneous viewing system
2, 2a, 2b, 2c, 2d, 2e server (remote simultaneous viewing management device)
3, 3a, 3b reproduction device
21, 21a content acquisition portion
22 content reproduction portion (reproduction portion)
24 zapping list acquisition portion (list acquisition portion)
25, 25b group switching portion (switching portion)
62, 62b, 62c, 62d group zapping processing portion (reception portion, switching portion, list generation portion)
64, 64d group information management portion (reception portion, switching portion, participation propriety setting portion)
65 friend setting portion

1. A reproduction device that is included in a remote simultaneous viewing system in which there are a plurality of groups, to each of which one or a plurality of users belong, and users who belong to a same group view a same content, the reproduction device comprising:
a reproduction portion that reproduces a content; and
a switching portion that switches a belonging group of a user of the reproduction device to a different group that views a content having a same attribute as that of the content reproduced by the reproduction portion.

2. The reproduction device according to claim 1, further comprising
a list acquisition portion that acquires a list in which a plurality of different groups are arrayed in a predetermined order, wherein
the switching portion performs switching to a different group in accordance with the order of the list acquired by the list acquisition portion.

3. The reproduction device according to claim 1, further comprising
a content acquisition portion that acquires a content from at least one of a broadcasting station, which is connected to the reproduction device via a broadcast network, and a transmission device which is connected to the reproduction device via the Internet, wherein
the reproduction portion reproduces the content acquired by the content acquisition portion.

4. A remote simultaneous viewing management device that is included in a remote simultaneous viewing system in which there are a plurality of groups, to each of which one or a plurality of users belong, and users who belong to a same group view a same content, the remote simultaneous viewing management device comprising:
a reception portion that receives a belonging group switching instruction from a reproduction device of a user; and
a switching portion that switches a belonging group of the user to a different group, which views a content having a same attribute as that of a content reproduced by the reproduction device, on a basis of the belonging group switching instruction received by the reception portion.

5. The remote simultaneous viewing management device according to claim 4, further comprising
a list generation portion that generates a list in which a plurality of different groups are arrayed in a predetermined order, wherein
the switching portion performs switching to a different group in accordance with the order of the list generated by the list generation portion.

6. The remote simultaneous viewing management device according to claim 4, further comprising
a participation propriety setting portion that, for each group, sets a user who is allowed to participate or not allowed to participate, wherein
the switching portion excludes, among the different groups, a group, in which the user of the reproduction device is not allowed to participate, from groups of a switching destination.

7. The remote simultaneous viewing management device according to claim 4, further comprising
a friend setting portion that, for each user, sets a friend indicating that the user and another user have a predetermined relation, wherein
the switching portion switches the belonging group of the user to a different group which views a content having the same attribute of that of the content reproduced by the reproduction device and to which another user who has the relation of the friend with the user of the reproduction device belongs.
